(19) United States
(12) Patent Application Publication
(10) Pub. No.: US 2017/0214213 A1
(43) Pub. Date: Jul. 27, 2017

(54) HIGH POWER LASERS, WAVELENGTH CONVERSIONS, AND MATCHING WAVELENGTHS FOR USE ENVIRONMENTS

(71) Applicants: Mark S. Zediker, Castle Rock, CO (US); Brian O. Faircloth, Evergreen, CO (US); Charles C. Rinzler, Denver, CO (US)

(72) Inventors: Mark S. Zediker, Castle Rock, CO (US); Brian O. Faircloth, Evergreen, CO (US); Charles C. Rinzler, Denver, CO (US)

(73) Assignee: FORO ENERGY, INC., Littleton, CO (US)

(21) Appl. No.: 14/099,948

(22) Filed: Dec. 7, 2013

Related U.S. Application Data
(60) Provisional application No. 61/734,809, filed on Dec. 7, 2012.
(60) Provisional application No. 61/786,763, filed on Mar. 15, 2013.

(51) Int. Cl. H01S 3/30; H01S 3/067; H01S 3/0941; H01S 3/16; E21B 43/24; E21B 29/02; E21B 7/15; E21B 29/06; E21B 43/11; H01S 3/094; H01S 3/109

(52) U.S. Cl. CPC H01S 3/302; H01S 3/094046; H01S 3/0675; H01S 3/09415; H01S 3/1603; H01S 3/06708; H01S 3/109; E21B 29/02; E21B 7/15; E21B 29/06; E21B 43/11; E21B 43/2405

(57) ABSTRACT

High power lasers and high power laser systems that provide high power laser beams having preselected wavelengths and characteristics to optimize or enhance laser beam performance in predetermined environments, conditions and use requirements. In particular, lasers, methods and systems that relate to, among other things, Raman lasers, up conversion lasers, wavelength conversion laser systems, and multi-laser systems that are configured to match and create specific and predetermined wavelengths at specific points along an optical path having varying requirements along that path.

This application claims, under 35 U.S.C. §119(e)(1), the benefit of the filing date of Dec. 7, 2012 of provisional application Ser. No. 61/734,809, and claims under 35 U.S.C. §119(e)(1), the benefit of the filing date of Mar. 15, 2013 of provisional application Ser. No. 61/786,763, the entire disclosures of each of which are incorporated herein by reference.

This invention was made with Government support under Award DE-AR0000044 awarded by the Office of ARPA-E U.S. Department of Energy. The Government has certain rights in this invention.

### BACKGROUND OF THE INVENTION

### Field of the Invention

The present inventions relate to high power lasers and high power laser systems that provide high power laser beams having preselected wavelengths and characteristics to optimize or enhance laser beam performance in predetermined environments, conditions and use requirements. In particular, the present inventions relate to, among other things, Raman lasers, up conversion lasers, wave length conversion laser systems, laser systems and multi-laser systems that can further be configured to match and create specific and predetermined wavelengths at specific points along an optical path having varying requirements along that optical path.

In using high power lasers to perform laser operations, there is a need to control the environment in which the laser, transmission fiber, laser tool, and beam path in free space to the target operate. Thus, the optical path of the laser beam, e.g., from and including the laser source to the work piece or target needs to be controlled to optimize laser transmission and laser operations. As laser powers increase from kilowatts, to tens of kilowatts, to hundreds of kilowatts of laser power the environmental problems and resulting needs to control the environment of the optical path increase, and in many instances increase exponentially.

As the use of high power lasers to perform laser operations in remote, distant, harsh and hazardous locations and environments increases, so will the environmental problems and needs to control those problems increase.

To date, it is believed that solutions to these problems have focused on regulating and controlling the environment along the optical path, such as for example the use of a wave guide compound laser jet to the deliver the laser beam from a laser tool through a non-transmissive media to the target. While these solutions can be highly effective, e.g., U.S. Patent Publication No. 2012/0074110, the entire disclosure of which is incorporated herein by reference, they focus on changing the environment to fit the laser beam, rather than changing the laser beam to fit the environment.

The present inventions take a different approach to solving these problems and meeting these needs for high power laser energy transmission and use; and an approach that before the present inventions in some situations was believed to be impossible. Thus, through the use of one, or a series of, high power lasers, custom laser beams can be provided along the optical path at location to optimize the laser beam to address the environmental needs present at that point, length, or area, along the optical path.

### SUMMARY

In using high power laser to perform laser operations, there has been a long standing need to address, mitigate and control the environment and conditions along the optical path of the laser beam. This need has increased with the introduction of long distance high power laser systems, and in particular, with introduction and use of such systems in remote, distant, harsh, and hazardous environments. The present inventions solve these, and other needs, by providing the articles of manufacture, devices and processes taught herein.

There is provided a high power Raman laser including: a conversion optical fiber having a proximal end and a distal end; the proximal end in optical association with a primary laser source for providing a primary laser beam to the conversion optical fiber; a means for obtaining at least a 3^{rd} order Raman emission providing an emission laser beam; and, a means for propagating the emission laser beam from the distal end of the conversion optical fiber.

Further there is provided, a high power Raman laser including: a conversion optical fiber having a proximal end and a distal end; the proximal end in optical association with a primary laser source for providing a primary laser beam to the conversion optical fiber; a means for obtaining at least a 5^{th} order Raman emission providing an emission laser beam; and, a means for propagating the emission laser beam from the distal end of the conversion optical fiber.

Further there are provided high power Raman lasers and methods that may also have on or more of the following features: wherein the means for obtaining the at least 3^{rd} order Raman emission includes the optical conversion fiber having a core diameter and length between the distal and proximal ends, whereby the at least 3^{rd} Raman emission is obtained; wherein the means for obtaining the at least 3^{rd} order Raman emission includes a grating to reflect the wavelength of the primary laser beam; wherein the means for obtaining the at least 3^{rd} order Raman emission includes a mirror to reflect the wavelength of the primary laser beam; wherein the means for obtaining the at least 3^{rd} order Raman emission includes a grating incorporated into the conversion fiber; and, wherein the means for obtaining the at least 3^{rd} order Raman emission includes a first grating or mirror associated with the proximal end of the conversion fiber and reflective to the backward propagation of the wavelength of the primary laser beam, and a second grating or mirror associated with the distal end of the conversion fiber and reflective of the forward propagation of the wavelength of the primary laser beam.

Moreover, there are provided high power Raman lasers and methods that may also have on or more of the following features: wherein the primary laser wavelength is about 1070 nm; wherein the primary laser wavelength is about 1060 nm to 1080 nm; wherein the primary laser beam is a broad band laser beam; wherein the primary laser wavelength is about 1060 nm to 1080 nm; wherein the means for obtaining the at least 3^{rd} order Raman emission includes the optical conversion fiber having a core diameter and length between the distal and proximal ends, whereby the at least 3^{rd} Raman emission is obtained; wherein the emission laser beam has a wavelength of about 1550 nm; wherein the means for obtaining the at least 3^{rd} order Raman emission includes the optical conversion fiber having a core diameter and length between the distal and proximal ends, whereby the at least 3^{rd} Raman emission is obtained; and, wherein the means for obtaining the at least 3^{rd} order Raman emission includes a first grating or mirror associated with the proximal end of the conversion fiber and reflective to the backward propagation of the wavelength of the primary laser beam, and a second grating or mirror associated with the distal end of the conversion fiber and reflective of the forward propagation of the wavelength of the primary laser beam.

Still further there is provided a a high power Raman laser including: a conversion optical fiber having a proximal end and a distal end; the proximal end in optical association with a primary laser source for providing a primary laser beam to the conversion optical fiber; a means for obtaining at least a 3^{rd} order Raman emission providing an emission laser beam; and, a means for propagating the emission laser beam from the distal end of the conversion optical fiber; and including; a means for obtaining at least a 3^{rd} order Raman emission providing a second emission laser beam; and, a means for propagating the second emission laser beam from the distal end of the conversion optical fiber.

Still further there is provided a a high power Raman laser including: a conversion optical fiber having a proximal end and a distal end; the proximal end in optical association with a primary laser source for providing a primary laser beam to the conversion optical fiber; a means for obtaining at least a 3^{rd} order Raman emission providing an emission laser beam; and, a means for propagating the emission laser beam from the distal end of the conversion optical fiber; and including; a means for obtaining at least a 3^{rd} order Raman emission providing a second emission laser beam; and, a means for propagating the second emission laser beam from the distal end of the conversion optical fiber; and, wherein the primary laser beam is a broad band laser beam; herein the primary laser wavelength is about 1060 nm to 1080 nm; and wherein the emission laser beam has a wavelength of about 1460 nm and the second emission laser beam has a wavelength of about 1660 nm.

Additionally, there are provided high power Raman lasers and methods that may also have one or more of the following features: wherein the primary laser has a power of at least about 10 kW; wherein the primary laser has a power of at least about 20 kW; wherein the primary laser has a power of at least about 50 kW; wherein the emission laser has a power of at least about 10 kW; wherein the emission laser has a power of at least about 20 kW; and, wherein the emission laser has a power of at least about 40 kW.

Still further there are provided high power Raman lasers and methods wherein a Raman emission is a stokes emission.

Yet additionally there are provided high power Raman lasers and methods wherein a Raman emission is an antistokes emission.

In addition there is provided a high power Raman laser including: a conversion optical fiber having a proximal end and a distal end; the proximal end in optical association with a primary laser source for providing a primary laser beam to the conversion optical fiber, the primary wavelength having a wavelength a power of at least about 20 kW; the conversion optical fiber capable of interacting with the primary laser beam to provide Raman scattering and to provide an increased order Raman emission having a power of at least about 5 kW; and, the distal end capable of transmitting the Raman emission.

Still further there are provide Raman lasers and methods that may include one or more of the following features: wherein a Raman emission is a stokes emission; wherein a Raman emission is an antistokes emission; wherein the emission laser beam wavelength is at least about 100 nm greater than the primary laser beam wavelength; wherein the emission laser beam wavelength is at least about 200 nm greater than the primary laser beam wavelength; wherein the emission laser beam wavelength is at least about 300 nm greater than the primary laser beam wavelength; and, wherein the emission laser beam wavelength is at least about 500 nm greater than the primary laser beam wavelength.

Yet still further, there is provided a method of converting the wavelength of a laser beam along an optical path through the generation of 3^{rd} order and greater Raman emissions, the method including: propagating a high power laser having at least about 10 kW of power along an optical path in a fiber, the optical path having a length and the fiber having a length; and generating 3^{rd} order Raman emissions along the optical path in the fiber.

Still further there are provide Raman lasers and methods that may include one or more of the following features: generating 5^{th} order Raman emissions; generating 6^{th} order Raman emissions; and generating 7^{th} order Raman emissions.

Still additionally there are provide Raman lasers and methods that may include one or more of the following features: wherein the optical path is longer than the fiber length; wherein the optical path is about the same length as the fiber; and, wherein the optical path is at least about 10× longer than the length of the fiber.

Furthermore, there is provided a method of converting in a borehole in the earth the wavelength of a laser beam along an optical path through the generation of 3^{rd} order and greater Raman emissions, the method including: positioning at least a portion of a fiber in a borehole in the earth; propagating a high power laser having at least about 10 kW of power along an optical path in the fiber, the optical path having a length and the fiber having a length; and generating 3^{rd} order Raman emissions along the optical path in the fiber.

Furthermore, there is provided a method of converting in a borehole in the earth the wavelength of a laser beam along an optical path through the generation of 6^{th} order and greater Raman emissions, the method including: positioning at least a portion of a fiber in a borehole in the earth; propagating a high power laser having at least about 10 kW of power along an optical path in the fiber, the optical path having a length and the fiber having a length; and generating 6^{th} order Raman emissions along the optical path in the fiber.

Yet still further, there is provided a method of converting in a borehole in the earth the wavelength of a laser beam along an optical path through the generation of 7^{th} order and greater Raman emissions, the method including: positioning at least a portion of a fiber in a borehole in the earth; propagating a high power laser having at least about 10 kW of power along an optical path in the fiber, the optical path having a length and the fiber having a length; and generating 7^{th} order Raman emissions along the optical path in the fiber.

Moreover there is provided a method of converting under the surface of a body of water the wavelength of a laser beam along an optical path through the generation of 3^{rd} order and greater Raman emissions, the method including: positioning at least a portion of a fiber under a surface of a body of water; propagating a high power laser having at least about 10 kW of power along an optical path in the fiber, the optical path having a length and the fiber having a length; and generating 3^{rd} order Raman emissions along the optical path in the fiber.

Yet additionally, there is provide an optical path multi-wavelength laser system, the system including: a primary laser for providing a first laser beam having a first wavelength and a power of at least about 20 kW; a first converter laser in optical communication with the primary laser, whereby the first laser beam is received by the first converter laser; the first converter laser capable of generating a second laser beam having a predetermined wavelength and a power of at least about 5 kW; and, the second laser beam wavelength selected based upon an environmental condition.

Additionally, there are provide Raman lasers and methods that may include one or more of the following features: wherein the environmental condition is long distance transmission of the laser beam over a fiber, and the wavelength is selected from the group consisting of about 1660 nm, about 1550 nm, and about 1460 nm; including a second converter laser in optical communication with the first converter laser, whereby the second laser beam is received by the second converter laser; the second upconverter laser capable of generating a third laser beam having a second predetermined wavelength and a power of at least about 3 kW; and the third laser beam wavelength selected based upon a second environmental condition; and, wherein the second environmental condition is borehole fluids, and the second wavelength is selected from the group consisting of about 880 nm and about 460 nm.

Additionally there is provide a high power Thulium rare earth ion conversion laser, the laser including: an optical fiber having a core and a cladding; the core including fused silica, Thulium and a dopant; the optical fiber having a distal end and a proximal end, whereby the proximal end is in optical association with a pump laser having a wavelength; and, the optical fiber, pump wavelength, amount of Thulium and amount of dopant, configured to provide stimulated emissions from the ³H₄ energy level, to provide a laser beam having a wavelength of about 810 nm.

Still further there are provided high power Thulium rare earth ion conversion laser wherein the dopant is selected from the group consisting of Germanium, and Alumina.

Moreover, there is provided a method of generating a high power laser beam in a borehole in the earth, the method including: lowering a Thulium conversion laser into a borehole; transmitting high power laser energy to the Thulium conversion; generating a laser beam having a wavelength of about 400 nm to about 900 nm within the borehole.

Still further there are provide Raman lasers and methods that may include one or more of the following features: wherein the wavelength is about 460 nm; wherein the wavelength is about 810 nm; wherein the laser beam is generated at a location at least 1,000 feet within a borehole and has a power of at least about 5 kW; wherein the laser beam is generated at a location at least 5,000 feet within a borehole and has a power of at least about 5 kW; wherein the laser beam is generated at a location at least 5,000 feet within a borehole and has a power of at least about 5 kW; wherein the laser beam is generated at a location at least 5,000 feet within a borehole and has a power of at least about 20 kW; wherein the laser beam is generated at a location at least 5,000 feet within a borehole and has a power of at least about 15 kW; and, wherein the laser beam is generated at a location at least 1,000 feet within a borehole and has a power of at least about 40 kW.

In addition there is provided a method of transmitting and using high power laser energy for drilling, pressure management, decommissioning, perforating or workover and completion activities, in the exploration or production of hydrocarbons, the method including: creating a first laser beam from a first laser, the first laser beam having a power of at least about 15 kW; transmitting the first laser beam to a second laser for creating a second laser beam; transmitting the second laser beam; and, delivering a laser beam from a high power laser tool to a target to perform a laser operation.

In addition there is provided a method of transmitting and using high power laser energy for drilling, pressure management, decommissioning, perforating or workover and completion activities, in the exploration or production of hydrocarbons, the method including: creating a first laser beam from a first laser, the first laser beam having a power of at least about 15 kW; transmitting the first laser beam to a second laser for creating a second laser beam; transmitting the second laser beam; and, delivering a laser beam from a high power laser tool to a target to perform a laser perforating operation.

In addition there is provided a method of transmitting and using high power laser energy for drilling, pressure management, decommissioning, perforating or workover and completion activities, in the exploration or production of hydrocarbons, the method including: creating a first laser beam from a first laser, the first laser beam having a power of at least about 15 kW; transmitting the first laser beam to a second laser for creating a second laser beam; transmitting the second laser beam; and, delivering a laser beam from a high power laser tool to a target to perform a laser fracturing operation.

In addition there is provided a method of transmitting and using high power laser energy for drilling, pressure management, decommissioning, perforating or workover and completion activities, in the exploration or production of hydrocarbons, the method including: creating a first laser beam from a first laser, the first laser beam having a power of at least about 15 kW; transmitting the first laser beam to a second laser for creating a second laser beam; transmitting the second laser beam; and, delivering a laser beam from a high power laser tool to a target to perform a laser decommissioning operation.

In addition there is provided a method of transmitting and using high power laser energy for drilling, pressure management, decommissioning, perforating or workover and completion activities, in the exploration or production of hydrocarbons, the method including: creating a first laser beam from a first laser, the first laser beam having a power of at least about 15 kW; transmitting the first laser beam to a second laser for creating a second laser beam; transmitting the second laser beam; and, delivering a laser beam from a high power laser tool to a target to perform a laser drilling operation.

In addition there is provided a method of transmitting and using high power laser energy for drilling, pressure management, decommissioning, perforating or workover and completion activities, in the exploration or production of hydrocarbons, the method including: creating a first laser beam from a first laser, the first laser beam having a power of at least about 15 kW; transmitting the first laser beam to a second laser for creating a second laser beam; transmitting the second laser beam; and, delivering a laser beam from a high power laser tool to a target to perform a laser pipe cutting operation.

In addition there is provided a method of transmitting and using high power laser energy for drilling, pressure management, decommissioning, perforating or workover and completion activities, in the exploration or production of hydrocarbons, the method including: creating a first laser beam from a first laser, the first laser beam having a power of at least about 15 kW; transmitting the first laser beam to a second laser for creating a second laser beam; transmitting the second laser beam; and, delivering a laser beam from a high power laser tool to a target to perform a laser window milling operation.

Moreover, there is provided a method of transmitting and using high power laser energy for drilling, pressure management, decommissioning, perforating or workover and completion activities, in the exploration or production of hydrocarbons, the method including: generating a first laser beam from a first laser, the first laser beam having a power of at least about 15 kW; transmitting the first laser beam to a second laser for generating a second laser beam, whereby the second laser generates the second laser beam; transmitting the second laser beam to a third laser for generating a third laser beam, whereby the third laser generates the third laser beam; transmitting the third laser beam to a laser tool; and delivering the third laser beam from the laser tool to a target; and, thereby performing a laser operation using the third laser beam on the target.

Still further there are provide Raman lasers and methods that may include one or more of the following features: wherein the first laser beam has a first wavelength, the second laser beam has a second wavelength, and the third laser beam has a third wavelength; the first, second and third wavelengths being different from each other; wherein the first wavelength is selected in part to enhance the generation of the second laser beam; wherein the second laser wavelength is selected in part to enhance the transmission of the second laser beam over fiber distances of at least about 1,000 feet; wherein the third wavelength is selected in part to enhance the transmission of the laser beam through a predetermined free space environment, the free space environment including an aqueous media; wherein the first wavelength is selected in part to enhance the generation of the second laser beam, the second laser wavelength is selected in part to enhance the transmission of the second laser beam over fiber distances of at least about 1,000 feet and to enhance the generation of the third laser beam, and the third wavelength is selected in part to enhance the transmission of the third laser beam through a predetermined free space environment, the free space environment including an aqueous media.

Moreover there is provided a high power laser system, the system including: a first laser for creating a first laser beam having a first wavelength and having a power of at least about 15 kW; a second laser for creating a second laser beam having a second wavelength, the second laser in optical communication with the first laser, whereby the first laser provides a pump source for the second laser; and, the second wavelength having a wavelength that is at least 500 nm smaller than the first wavelength.

Additionally there is provided a high power laser system, the system including: a first laser for creating a first laser beam having a first wavelength and having a power of at least about 10 kW; a second laser for creating a second laser beam having a second wavelength, the second laser in optical communication with the first laser, whereby the first laser provides a pump source for the second laser; the second laser in optical communication, by way of a high power laser fiber having a length of at least about 2,000 feet, with a third laser for creating a third laser beam, whereby the second laser beam provides a pump source for the third laser; and, the third laser in optical communication with a laser tool, whereby the laser tool is configured to deliver the third laser beam to a target.

Still further there are provide Raman lasers and methods that may include one or more of the following features: wherein the first wavelength is selected in part to enhance the pumping of the second laser, the second laser wavelength is selected in part to enhance the transmission of the second laser beam over fiber and to enhance the pumping of the third laser, and the third wavelength is selected in part to enhance the delivery of the third laser beam to the target through a predetermined free space environment, the free space environment including an aqueous media.

### BRIEF DESCRIPTION OF THE DRAWINGS

FIG. 1 is a schematic view of a laser conversion system of the present invention in accordance with the present inventions.

FIGS. 2A and 2B are charts showing spectra in accordance with the present inventions.

FIG. 3 is a chart showing spectra in accordance with the present inventions.

FIG. 4 is schematic of energy levels and transition in accordance with the present inventions.

FIG. 5 is a schematic of energy levels and transition in accordance with the present inventions.

FIG. 6 is a schematic of energy levels and transition in accordance with the present inventions.

FIGS. 7A and 7B are a schematic of a spectra and corresponding chart regarding energy levels in accordance with the present inventions.

FIGS. 8A and 8B are a schematic of a spectra and corresponding chart regarding energy levels in accordance with the present inventions.

FIG. 9 is a fluorescence vs pump power in accordance with the present inventions.

FIGS. 10A, 10B and 10C are spectras and plots in accordance with the present inventions.

FIG. 11 is a schematic of an embodiment of a laser converter in accordance with the present inventions.

FIG. 12 is a schematic of an embodiment of a laser converter in accordance with the present inventions.

FIG. 13 is a perspective phantom line view of an embodiment of a laser drilling bit in accordance with the present inventions.

### DESCRIPTION OF THE PREFERRED EMBODIMENTS

In general, the present inventions relate to the use of high power lasers, and in particular, to the novel high power lasers and lasing processes, which can provide custom laser beam wavelengths, at specific locations along the optical path to address, mitigate and optimize laser transmission, laser operations, and laser processes on a target and combinations and variations of these. Further, the present inventions relate to systems of one or more such lasers and process configured in a custom laser system to address multiple, different or both, problems, systems requirements, and environmental conditions along the optical path.

Thus the present inventions relate to methods, apparatus and systems for the delivery of high power laser beams to a target, and in particular, a work surface that may be located on a factory floor, may be in remote, hazardous, optically occluded and difficult to access locations, such as: oil wells, boreholes in the earth, pipelines, underground mines, natural gas wells, geothermal wells, surface mines, subsea, nuclear reactors, or in other environments. Further, and in general, the present inventions relate to high power laser systems, tools, process and operations that may be used with, as a part of, or in conjunction with, systems, methods and tools for applying laser energy for performing laser applications and laser assisted applications such as cutting, heat treating, thermal processing, annealing, cladding, hard facing, welding, advancing a borehole, workover and completion, removing material, monitoring, cleaning, controlling, assembling, drilling, machining, powering equipment, milling, flow assurance, decommissioning, plugging, abandonment and perforating.

Generally, the optical path of a laser system is the entire distance that the laser beam is propagated along from the source of the laser beam, e.g., the laser, through optical components, such as an optical fiber, a connector, a lens, a window and through free space to a target, e.g., a pipe, casing, borehole surface, etc. In transmitting the laser beam along the optical path different and varying consideration and requirements may arise at different locations along the optical path. Thus, for example, if the target is a long distance away from the laser source, e.g., 1,000, ft, 5,000 ft, 15,000 ft or more, particular wavelengths, or wavelength ranges, may have greater abilities for transmission, e.g., lower losses, over these distances for particular fibers, e.g., for silica fibers wavelength of 1070 nm and more preferably 1550 nm. If the target is located in an environment, which constitutes a portion of the free space along the optical path, particular wavelengths, or wavelength ranges, may have greater abilities for transmission, e.g., lower losses, through these free space environments of the optical path, e.g., for aqueous environments wavelengths of 810 nm and more preferably 530 nm.

Over an optical path for a system there may be one, two or more free space environments, as well as, optical components of different lengths, compositions, reflectivity, compositions, etc. Thus, a laser beam having a predetermined wavelength can be selected for enhanced, superior and preferably optimum performance in a component or section of the optical path, another laser beam having a predetermined wavelength can be selected for enhanced, superior and preferably optimum performance in another component or section of the optical path, a third laser beam having a predetermined wavelength (which may be the same as one of the other wavelengths along the optical path) can be selected for enhanced, superior and preferably optimum performance in a component or section of the optical path. Four and more wavelengths may be selected for enhanced, superior and preferably optimum performance in a components or sections of the optical path. The wavelength may also be selected for enhanced, superior and preferable optimum performance on, or with respect to, a particular target material. In addition to selecting wavelengths for optimum performance along a particular section of the optical path, the relationship of these wavelengths to each other can be optimized, and in this manner the overall performance of the laser beam system can be optimized.

In many situations one or more tradeoffs, or conflicting performance features, may be present along the optical path. Thus, for example, a first wavelength that is highly desirable for use in a first section of the optical path, may be less optimal and may even be undesirable for use in a second section of the optical path. Thus, the laser wavelength may be converted from the first wavelength after transmission through the first section of the optical path into a second wavelength for transmission through the second section of the optical path.

In particular, when using opto-to-opto conversions, e.g., a laser beam of one wavelength to a laser beam of a different wavelength, considerations should be given to creating the second laser beam wavelength along the optical path from the first laser beam, e.g., laser beam or wavelength conversion. Thus, the ability of the first laser beam to pump, cause, or otherwise drive, the lasing of the second laser beam should be taken into consideration. These considerations involve among other things, optical state transitions, e.g., energy level transitions of photons, as well as the efficiencies of these transitions, or conversions. Thus, tradeoffs may be made between the first laser beam wavelength and the second laser beam wavelength to enhance, balance, or optimize the system along the entirety of the optical path. For example, a less than optimal second wavelength may be selected because it can be create by a first wavelength having optimum performance. Similarly, a less than optimal first wavelength may be used because it provides for a highly efficient conversion of the first wavelength to the second wavelength. In this manner the overall system along the optical path can be preferably be optimized, by selecting and balancing these various considerations.

Further, although the primary focus of this specification is on the selection, use, and conversion of wavelengths, other laser beam parameters may be used to enhance and optimize the transmission of the laser beam along the optical path, such as for example fluence. While opto-to-opto, e.g., a laser beam to a laser beam, conversions are preferred, opto-electric-opto conversions may be utilized, and electrical to opto may be used, and could be preferable, such as a high power laser down hole having a wavelength selected for enhanced, superior and preferable optimum transmission through a particular free space.

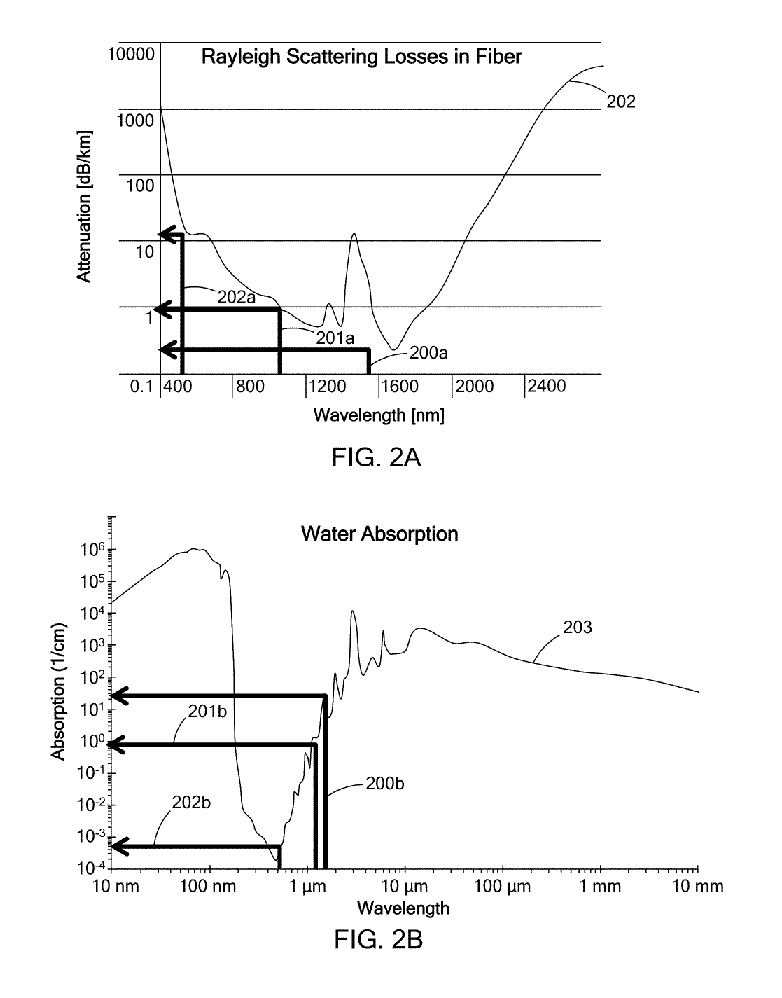

Thus, turning to FIGS. 2A and 2B there are shown graphs of the absorption or losses of various laser wavelengths over particular conditions along the optical path of a system. In FIG. 2A the plot 202 shows the Rayleigh scattering losses in a transmission fiber for various wavelengths. Arrow 200a shows the loss for 1550 nm (<0.25 dB/km), arrow 201a shows the loss for 1070 nm (0.6 dB/km) and arrow 202a shows the loss for 532 nm (10 dB/km). Thus, for long distance transmission 1550 nm wavelength would be the optimal wavelength of those called out in the figure. In FIG. 2B the plot 203 shows the water absorption for various wavelengths. Arrow 200b shows the absorption for 1550 nm (>95%/mm), arrow 201b shows the absorption for 1070 nm (>25%/inch), and arrow 201c shows the absorption for 532 nm (>0.1%/inch). Thus, for transmission through a free space environment having water 532 nm would the optimal wavelength of those called out in the figure. This illustrates an example of one of the paradigms that is present where the optimum wave length for long distance transmission is the worst wavelength for delivery through a particular free space environment of use. Although, 1550 nm, 1070 nm, and 532 nm wavelengths were called out in these figures to illustrate the relationship between competing factors over the optical path. The plots 202 and 203 show that other wavelengths may be optimal or desirable for use. Additionally, is is noted that the chart of FIG. 2A, also shows impurity vibrational absorption states. More specifically, the peak from 1300 nm to 1600 nm is an OH⁻ absorption band. Preferably, an ultra pure fiber can be used to transmit the laser, which would eliminate such impurities and their related absorption peak would not be present.

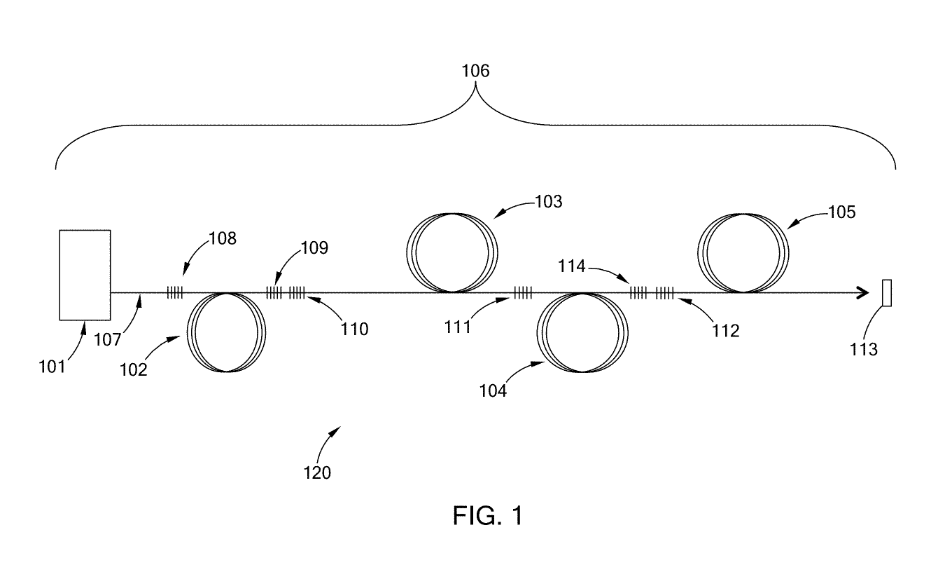

Turning to FIG. 1 there is provided an embodiment of an optical path multi-laser system 120, for providing laser energy to a remote location, such as a borehole deep within the earth. There is provided a first laser 101, a second laser 102, a long distance transmission fiber 103, a third laser 104, and a delivery fiber 105, which delivers the laser beam to a target 113, through free space along the optical path, such as a surface of a borehole. The system further has nested gratings or external broadband mirrors 108, 109, an HR grating or mirror 110, an HR grating 111, partially reflective grating 114, and an HR grating or mirror 112. In this embodiment the lasers are designed to provide specific wavelengths to address requirements along the optical path 106. The optical path 106 would include all elements that the laser beam is intended to pass through, including free space, along its intended path from the primary or first laser 101 until it strikes the intended target upon which the laser operation is to be performed. It is further noted that the length of the optical path would also include the length of the path that the laser beam takes between reflective gratings when in the second or third laser.

Laser 101 is a surface unit that has a good conversion of electrical energy to optical energy, and has the requisite reliability and robustness to be present at for example a drill site, on a drill ship, or in a nuclear or chemical facility. Laser 101 provides a first laser beam along the optical path 106. In the embodiment of FIG. 1, this first laser beam is a 20 kW laser beam at a wavelength of 1070 nm. The wavelength and power of the first laser beam is selected, and is based upon the requirements and outputs of the other lasers, and environments, along the optical path 106.

The wavelength of the first laser beam provided by the first laser 101 along the optical path 106, relates to and should meet the requirements of the second laser 102 along the optical path 106. In turn the second laser beam provided by the second laser 102, relates to and should meet the requirements of the third laser 104 along the optical path 106. If additional lasers, and wavelengths are utilized along the optical paths similar relationships amongst the laser should be present. Thus, in a multi-laser system, having n lasers positioned serially along the optical path, the wavelength of the first laser, e.g., the primary laser, will be based upon, or selected in part, based upon the requirements of the other lasers, and may include the requirements of the n^{th} laser along the optical path.

The first laser 101 is a 1070 nm fiber laser pump with broad spectral characteristics. The first laser beam, having a 1070 nm wavelength, exits laser 101, e.g., is launched into optical fiber 107 and travels to laser 102, where it drives, pumps, or otherwise causes laser 102 to propagate a second laser beam, having a wavelength of 1550 nm, which is launched into the long distance transition fiber 103. Laser 102 is a 7^{th} order Raman converter with a distal pump reflector. It has a 7^{th} order nested grating or an external broadband mirror 108, on the proximal end of a 100 m conversion fiber having a core that is matched to the fiber laser core, and a 7^{th} order nested grating or an external broadband mirror 109 and a 1070 nm HR grating or mirror 110 on the distal end of that conversion fiber.

In this manner the 1070 nm wavelength laser beam is converted to a second laser beam having a 1550 nm wavelength laser beam by the second laser 102. Thus, this conversion of the first laser beam to the longer wavelength of the second laser beam may be referred to as a conversion, and a conversion along the optical path of the laser beam in the laser system 120.

The 1550 nm laser wavelength is selected for the purpose of minimizing losses over long distance fiber transmission of the laser beam. By way of comparison the 1070 nm wavelength laser beam would have about 0.6 dB/km losses when being transmitted through the long distance transmission fiber 103, and the 1550 nm wavelength would have substantially smaller losses of about less than 0.25 dB/km when being transmitted through the long distance transmission fiber 103, which is about 5 km long. Thus, one of the purposes of selecting and providing a 1550 nm wavelength laser beam is to address, manage or mitigate the environmental or systems requirement to minimize power losses over long distance fiber transmissions.

The 1550 nm wavelength laser beam travels along the 5 km of transmission fiber 103 to laser 104, where it has a power of about 13 kW, and drives, pumps, or otherwise causes laser 104 to propagate a third laser beam having a wavelength of 810 nm. Laser 104 is a cladding pumped Thulium laser with Germania doping. It has an 810 nm HR grating on the proximal end of a 35 m conversion fiber, which has the same secondary cladding diameter as the transmission fiber 103 core diameter, and an 810 nm 5% R grating 114 and a 1550 nm HR grating or mirror 112 on the distal end of the 35 m conversion fiber. The 810 nm laser beam is launched from laser 104 into and travels along the delivery fiber 105. The delivery fiber 105 is connected to a downhole laser tool (not shown in the figure) where the tool launches the laser beam into the borehole toward the borehole surface to perform a laser operation such as advancing the borehole, perforating, cutting a window, removing a plug or other downhole operations, including workover and completion operations. In this manner the second laser beam having a wavelength of 1550 nm is converted, by the third laser 104 to a third laser beam, having a wavelength of 810 nm and a power of about 9.9 kW. The 810 nm wavelength is selected to provide the ability to use water as a delivery medium, while minimizing power losses. Thus, a laser water jet could be used, with minimal absorption, (and thus minimal power loss), by the water, to transport the laser beam through the fluids present in the borehole, e.g. through the free space environment of the borehole along the optical path. For example, the 810 nm wavelength laser beams has minimal absorption, e.g., power loss, in water, about 4%/inch, when compared to the 100%/inch absorption of the 1550 nm wavelength laser beam and the >20%/inch absorption of the 1070 nm wavelength laser beam.

Thus, the power efficiency of the system for the opto-to-opto conversions is about 49%. Systems having greater and lower power efficiencies are envisioned. Thus, the opto-to-opto power conversion efficiency of a two laser optical path system can be from about 20% to about 75% or more, the opto-to-opto conversion efficiency of a three laser system can be from about 20% to about 60% or more, and generally four and five laser systems can will have lower conversion efficiencies.

Table 1, provides an example of an embodiment of the power conversion efficiencies for a laser converter along an optical path

TABLE 1

| | | Power | Transmission | Power | Transmission | Power |
|---|---|---|---|---|---|---|
| | Transmission | Budget | (1550 nm) | Budget | (1550 nm) | Budget |
| | (1070 nm) | (1070 nm) | Worse Case | (1550 nm) | Best Case | (1550 nm) |
| Power Input | | 20,000 W | | 20,000 W | | 20,000 W |
| Power Trans 5 km | 45% | 8,934 W | 71% | 14,159 W | 71% | 14,159 W |
| Power Conversion to 810 | | | 56% | 7,929 W | 76% | 10,761 W |
| Power Trans (2″) | 49% | 4,377 W | 97% | 7,693 W | 97% | 10,440 W |
| Power Trans (6″) | 12% | 1,051 W | 91% | 7,242 W | 91% | 9,828 W |

Thus, turning back to the embodiment of FIG. 1, for example as deployed for use in a borehole in an oil field, the second laser 102 may be located above ground, or may be positioned partially or totally within the borehole. In off-shore drilling operations, the second laser 102 may be located on the drilling rig, above the surface of the water, or it may be positioned partially, or totally below the surface of the body of water, and/or partially or totally with in the borehole below the sea floor. The length of the optical path, the transmission fiber, and the delivery fiber may vary depending upon the system requirements and applications. Additionally, the length of the conversion lasers along the optical path may vary and this length, along with other factors, may be used to select, and/or tune, the wavelength of the laser beam propagated by these lasers. Further, all the components along the optical path, preferably, should have shielding, protection, break detection provided for them. For example they may be contained in a conveyance structure or umbilical.

Additionally, if greater laser power is required for the intended downhole or remote laser operation to be performed, or more preferably, be performed in an efficient manner, one, two, three or more multi-laser systems of the general type shown in the embodiment of FIG. 1 may be incorporated or associated with a single umbilical and laser tool.

An example of an embodiment of the second laser is a high power Raman laser. In particular this laser may be a fiber that is pumped by a broad band 1070 nm to create gain as a result of the non-linear Raman scattering phenomenon to reach a 7^{th} order stokes emission of the laser beam wavelength having a wavelength of 1550 nm. This may be accomplished in a shorter, relatively speaking, 100 m length of fiber having gratings, mirrors, or photonic crystals, or other optical devices to enable the 7^{th} order to be reached and propagated from the fiber. It may also be obtained by having a fiber of sufficient length, for a given core diameter, to reach the 7^{th} order wavelength of 1550 nm.

An example of an embodiment of the second laser is a high power Raman laser. In particular this laser may be a fiber that is pumped by a broad band 1070 nm to create gain as a result of the non-linear Raman scattering phenomenon to reach a 3^{rd} order stokes emission of the laser beam wavelength having a wavelength of 1550 nm. This may be accomplished in a shorter, relatively speaking, length of fiber having gratings, mirrors, or photonic crystals, or other optical devices to enable the 3^{rd} order to be reached and propagated from the fiber. It may also be obtained by having a fiber of sufficient length, for a given core diameter, to reach the 3^{rd} order wavelength of 1550 nm.

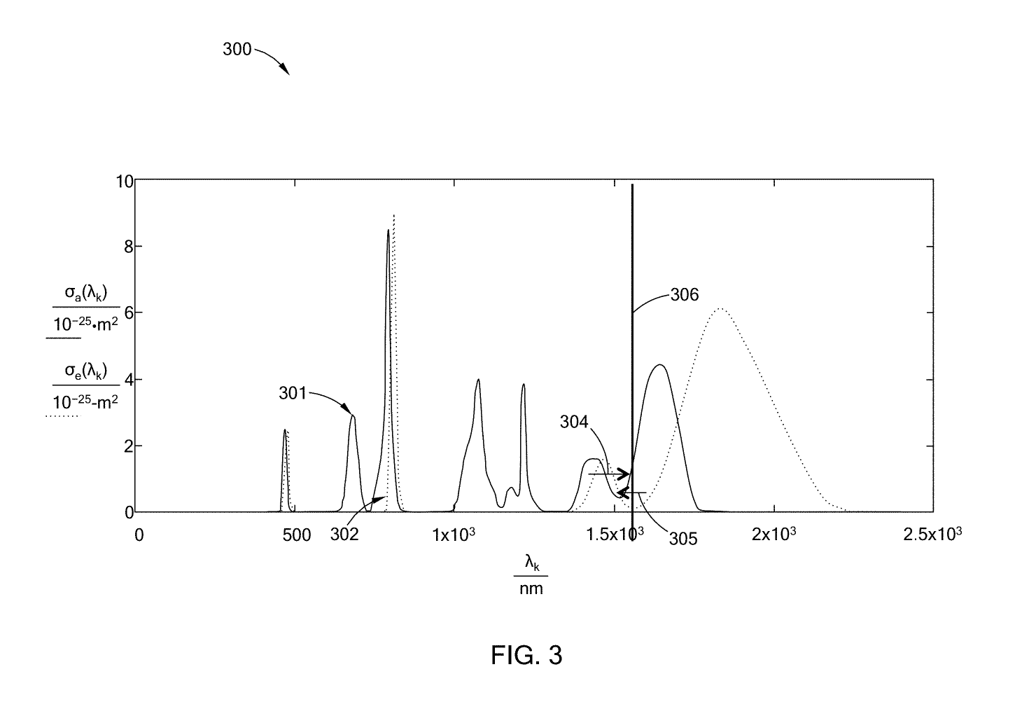

Turning to FIG. 3, there is shown a graph showing the absorption characteristics of a Thulium doped fiber. In order to pump the upconversion band, it is necessary to find a dopant for the fiber than can effectively shift the absorption spectrum at 1600 nm to a shorter wavelength while simultaneously shifting the excited state absorption band at 1470 nm to a longer wavelength. Line 306 shows 1550 nm and indicates the amount of wavelength shift required, as illustrated by arrows 304, 305.

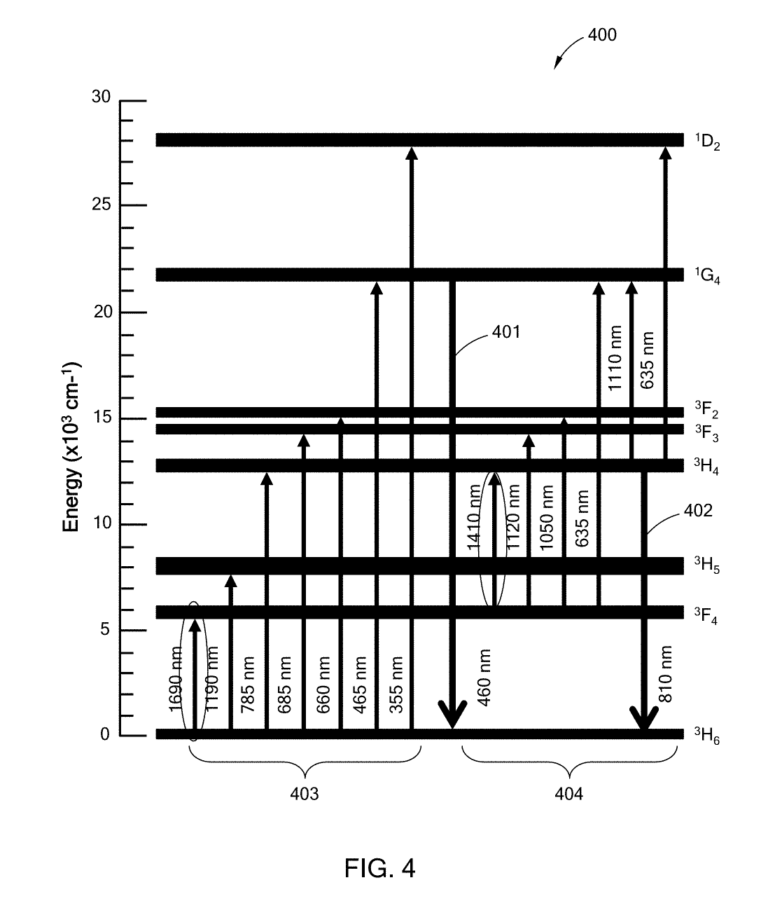

Turning to FIG. 4, there is shown a chart 400 of Thulium energy levels. The chart shows ground state absorptions 403 (upward arrows) and excited state absorptions 404 (upward arrows) for particular wavelengths (as illustrated in the figure). Arrows 401 and 402 show emissions at wavelengths 460 nm and 810 nm (which wavelengths have minimal absorption by water, see FIG. 2B). Thulium rare earth ion upconversion lasers can convert three 1070 nm photons to one 460 nm photo, or they it can convert one 1690 nm photon and one 1480 nm photon to one 810 nm photon. Further, a Thulium core fiber that is doped with Germanium can convert two 1550 nm photons to 810 nm photons. A Thulium core fiber can be doped with Alumina and convert one photon in the 1400s nm wavelength range, and one photon in the 1500s nm wavelength range or one photon in the 1600s nm range, to 810 nm. Thus, a laser source providing multiple wavelengths in the 1400s, 1500s and 1600s nm ranges can simultaneously provide these multiple wavelength laser beams to a Thulium fiber conversion laser to produce a laser beam at 810 nm. As seen in FIG. 2A, these pump wavelengths have low Rayleigh scattering losses over long distances.

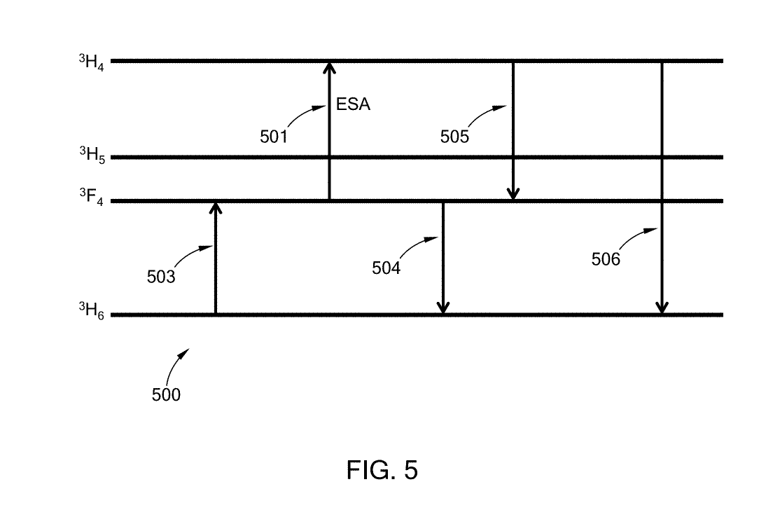

The energy state upconversion process for an embodiment of a Thulium laser is further illustrated in FIG. 5, where energy levels 500 are shown, with a pump wavelength arrow 503 (of 1586 nm), and Excited State Absorption (ESA) wavelength of 1470 nm (arrow 501), and, and emissions arrows 505 (1480 nm), 504 (1800 nm) and 506 (800 nm) are shown.

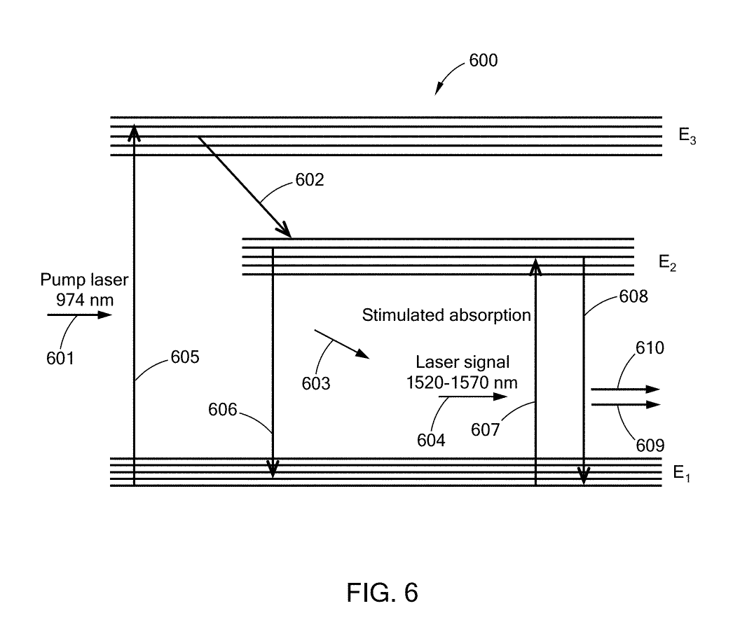

Turning to FIG. 6 there is shown the energy levels 600 for an embodiment of an Erbium laser using a pump laser 601 having a wavelength of 974 nm is provided that when absorbed pumps 605 an electron from the lower E₁ state to the high E₃ state. The upper laser state E₂ can further be resonantly pumped 609 by photons absorbed over the band of 1520 nm to 1570 nm (arrow 604) and reemitted at a slightly longer wavelength ranging from 1521 to 1570 nm (arrows 609, 610). The only criteria for resonantly pumping the upper state is that the emission wavelength must be slightly longer than the absorption wavelength. The advantage of resonantly pumping the upper state is the substantial improvement in the quantum defect for this state compared to pumping E₃ with a 974 nm laser. This significant reduction of the pump quantum defect has two beneficial effects, a dramatic reduction in the heat generated in the fiber and a substantial improvement in the overall efficiency of the laser. This laser can be pumped at a short wavelength such as 1520 nm (shown by arrow 604) and laser at two or more longer wavelengths, for example, 1550 nm (shown by arrow 609) and 1570 nm (shown by arrow 610). Multiple lines can be made to oscillate, or different wavelength lasers can be combined to produce the desired spectrum to maximize the 810 nm output. There is also an upconversion process in Eribum, where two 974 nm pump photons can be absorbed to produce a 537 nm photon or a 548 nm photon. The resulting green laser light is ideally suited for transmission through water. Further, arrow 602 is relaxation from the higher lying E₃ state to the upper laser state E₂, this relaxation is typically caused by collisions with other molecules, transferring heat (phonons) into the host matrix such as glass. Arrow 603 is the spontaneous emission spectrum that can occur from E₂ when pumped by E₃ through the relaxation reaction 602. The spontaneous emission is lost energy because it is radiated in all directions and does not contribute to the laser signal. Arrow 607 is the pumping of an electron from the ground state to the first excited state E₂ by the resonant absorption process. Arrow 608 is the stimulated emission causing the electron to drop from the upper laser state to the ground state as the energy is converted into coherent emissions, 609, 610.

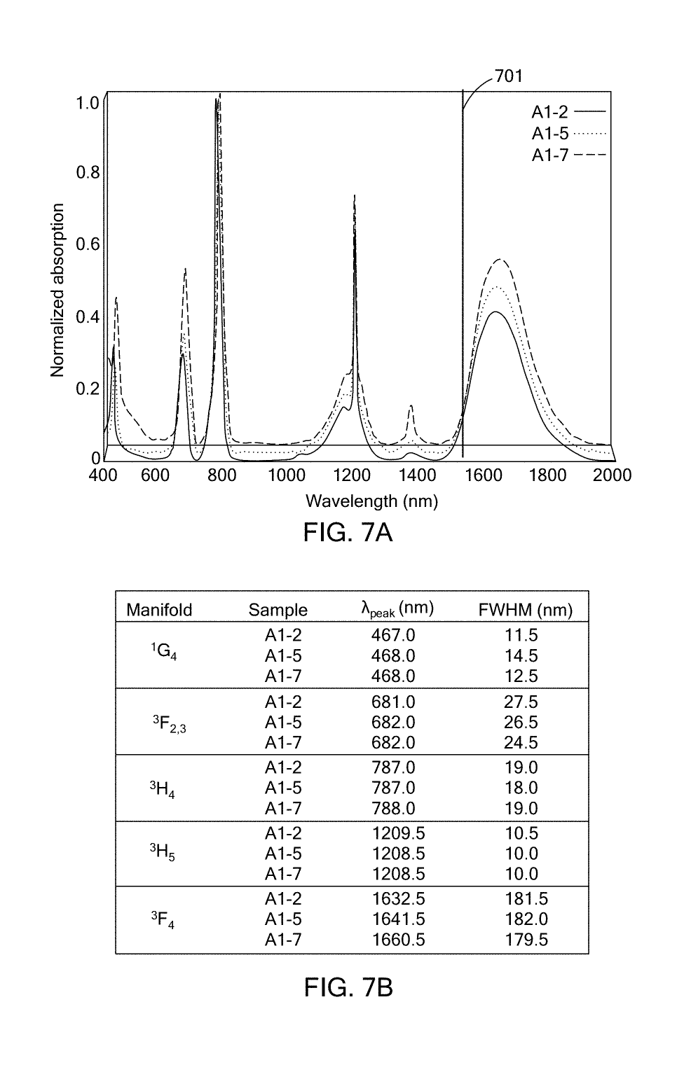

Turning to FIGS. 7A and 7B there is shown a graph and chart respectively of Alumino-Silica glass absorption spectra and energy levels. As the alumina concentration is decreased, the ³F₄ state absorption shifts from 1660 nm to 1632 nm. This blue wavelength shift observed as a function of the alumina concentrations is an indication that dopants in the core can be used to blue shift the ³F₄ absorption to absorb at 1550 nm (shown by line 701).

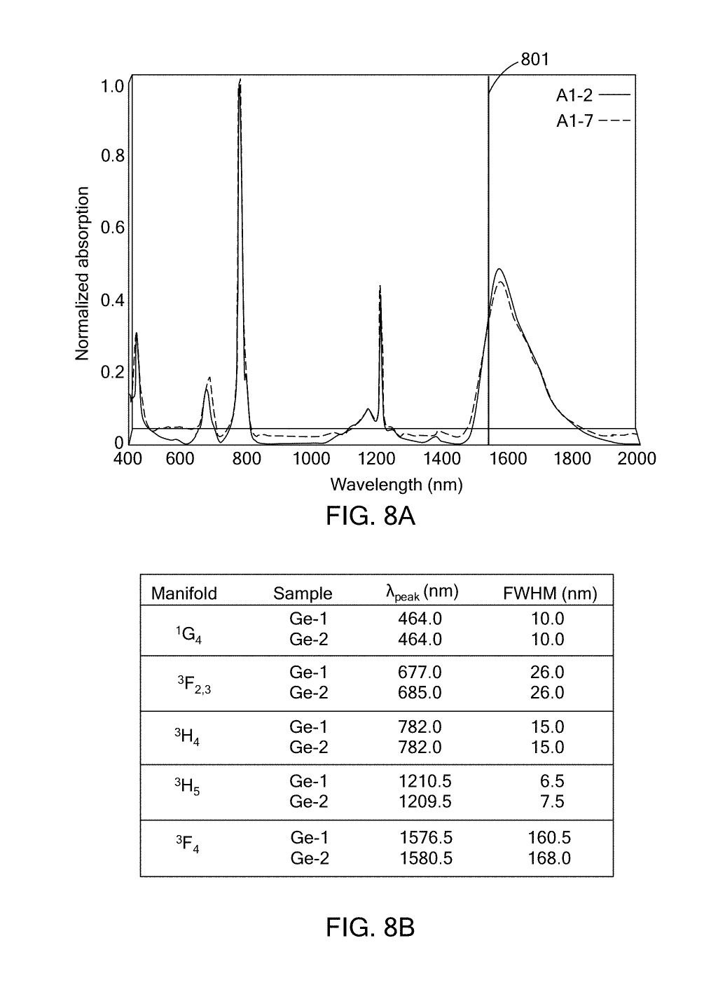

Turning to FIGS. 8A and 8B there is shown a graph and chart respectively of Germano-Silicate doped glass absorption spectra and energy levels. The presence of a Germano doping in the core of the fiber causes the ³F₄ absorption spectrum to blue shift by over 60 nm resulting in substantial absorption at 1550 nm. However, there is no indication of what happens to the excited state absorption from the ³F₄ to the ³H₄ at 1470 nm to be found in the literature. However, the absorption spectrum from the ³H₆ to the ³H₄ state does not shift significantly when there is either Germano or Alimina dopants. From this observation and recognizing that conservation of energy applies to these energy states the absorption spectrum for the excited state level (ESA) must red shift from 1470 nm to 1542 nm. This shift in the ESA is precisely what is need for the two absorption spectrums to align at 1550 nm (shown by line 801) and allow direct pumping using two 1550 nm photons from the ground state to the 810 nm upper laser state.

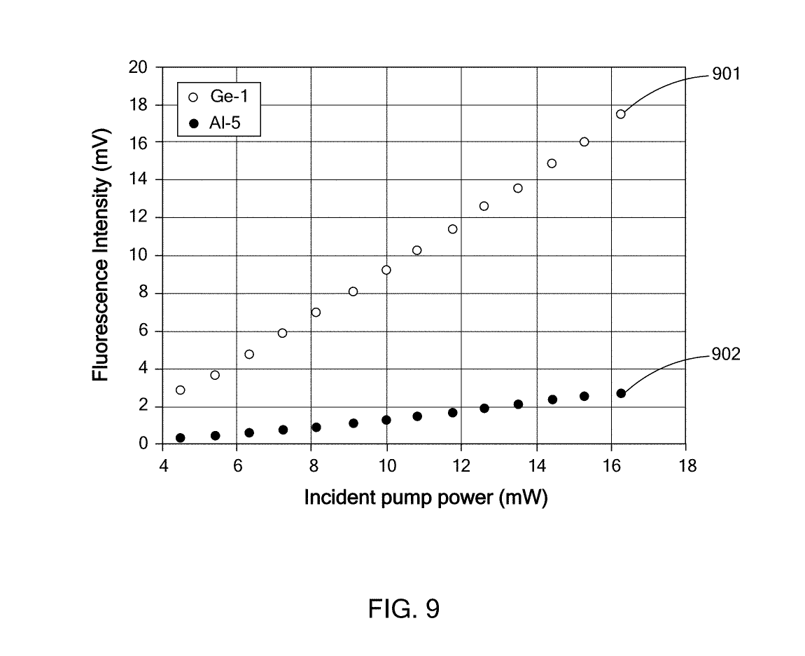

Turning to FIG. 9 the fluorescence intensity at 810 nm is plotted as a function of the pumping power for two cases, 902 which is an alumino-silicate doped core and 901 which is a germane-slicate doped core. The greatly enhanced fluorescence intensity is an indication that the absorption spectrum for the ground state and the absorption spectrum for the excited state (ESA) are aligned allowing two 1550 nm photons directly pump the upper laser state.

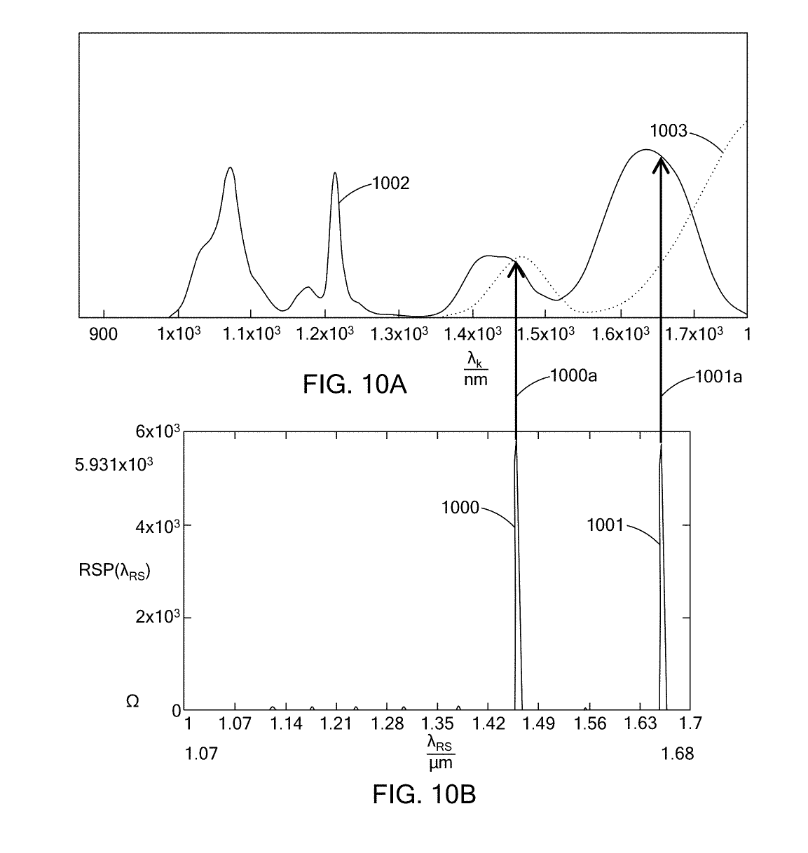

Turning to FIGS. 10A, 10B and 10C there are shown charts showing the relationships of an embodiment of a dual wavelength source optical path system. In this a Raman laser, which for example could be the second laser in the embodiment of FIG. 1, provides two laser beam having different wavelengths (peaks 1000, 1001), these two laser beams are then combined into a single optical fiber that is then used to pump a Thulium laser, for example the third laser in the embodiment of FIG. 1, to produce a laser beam having a wavelength in the 800s nm range. The two laser beams (wavelengths 1000, 1001) are combined into a single optical fiber that has the same wavelength as the absorption spectrum for the ground state 1001, 1001a and the excited state absorption 1000a. (As used herein unless specified otherwise, the use of the term “x00s nm range,” means wavelengths from x00 to x99, e.g., 800 to 899 nm, and the term “about” means a variation of 10% or less.) A dual wavelength laser source can be used to directly pump a pure silica core or an Alumina doped core that is co-doped with Thulium to produce a laser beam in the 800s nm range. The Raman laser has a partial reflector at the output coupler for the first wavelength (1460 nm) and for the second wavelength (1550 nm or 1660 nm) plus a broadband anti-reflection coating at the end of the fiber to prevent any further Raman orders oscillating. Thus, as seen in FIG. 10B the peak 1000 correspond to 1460 nm and the peak 1001 corresponds to 1660 nm. The relationship of these peaks 1000, 1001 are shown to the absorption spectrum for the Thulium fiber which is the solid line 1002. The emission spectrum for Thulium is doted line 1003. FIG. 100 shows the power out at 810 nm vs power in plots—plot 1005 shows the power plot (total at 1460 and 1660 nm)—plot 1004 shows a peak efficiency of nearly 70% for a 4 m long fiber with either a 5% or 10% output coupler. The two charts are nearly identical because of the high gain for the transition is not effected by the round trip losses. Another example of an embodiment of the second laser is a high power Raman laser that provides one laser beam with different wavelengths, from different orders of stokes emissions. For example, laser beams having wavelengths of 1460 nm and 1660 nm may be propagated.

In addition to Raman anti-stokes lasers, non-linear conversion lasers, frequency doubling lasers, and sum frequency mixing lasers may be used as the laser converter along, or within, the optical path.

Depending upon the the incoming, or pump, wavelength, beam quality such as band width, and other factors including for example the structure, length and composition of the conversion fiber, as well as temperature and strain on the fiber, different Raman orders may be obtain and thus other wavelengths in addition 1550 nm, 1460 nm, and 1660 nm, may be emitted and propagated.

It should further be noted that only a second laser may be used in the multi-laser system, that embodiments of the second laser may be positioned as the third, fourth, or n^{th} laser along the optical path, and similarly, embodiments of the third laser may be positioned along the optical path as the second, fourth, or n^{th} laser along the optical path. And that other types of lasers in addition to those disclosed in this specification may be positioned along the optical path of a multi-laser system.

The third laser may be a Thulium rare earth ion conversion laser, which has its core doped with Germania and/or Alumina. The Thulium laser relies upon reaching the ³H₄ energy state to emit a laser beam at 810 nm. Other energy states and wavelengths and combinations of pumped wavelengths may be envisioned to provide 810 nm wavelengths or 460 nm wavelength laser beams, which have minimal absorption in water.

While water is a preferred fluid for transmission and use in a borehole, or related activities regarding the exploration and production of hydrocarbons and geothermal energy, other fluids may be utilized and may be preferable for other applications in those fields and in other other fields. Thus, a third, or the last laser on the optical path before the target, which thus provides the operative laser beam, having an operative wavelength, can be selected to provide a laser beam having a wavelength that is selected to provide efficient transmission through that media, to provide efficient or enhance interaction with the intended target, and combinations and variations of these. By operative wavelength it is meant the wavelength of the laser beam that is delivered to the target and/or used to perform the intended laser operation.

### Example 1

A Raman convertor laser having a fiber having a 25 μm diameter fused silica core, a clad of 250 μm, multi-mode having a length of 60 m. The Raman converter laser is pumped by a 1070 nm laser beam, which may be about 4 or 5 kW. The fiber has a single wavelength grating at the input and distal end and is designed to create a pump for a 6^{th} order nested grating Raman laser. The gratings are written in a 25 μm core or smaller. In the place of a grating an eternal mirror may be used.

### Example 2

A Raman converter laser is pumped by a 20 kW fiber laser running in a pulsed mode. The pump laser is operated at a period of 101 ms and a pulse width of 1.0 ms, with a duty cycle of 0.89%.

### Example 3

The laser converter of example 2 is operated with a pulse width of 1 ms to 50 ms, and a duty cycle from 10% to 50%

### Example 4

A Raman convertor laser having a fiber having a 25 μm diameter fused silica core, a clad of 250 μm, multi-mode having a length of 130 m, and may have a power of about 4 or 5 kW. The fiber has a single wavelength grating at the input and distal end and is designed to create a pump for a 6^{th} order nested grating Raman laser. The gratings are written in a 25 μm core or smaller. In the place of a grating an eternal mirror may be used.

### Example 5

A laser drilling system of the type disclosed in US Patent Application Publ. No. 2010/0044103, the entire disclosure of which is incorporated herein by reference, utilizes a laser conversion system of the type shown in FIG. 1. Thus the system has a two 40 kW laser above ground providing two laser beams at 1070 nm. These laser beams are converted to laser beams having 1550 nm by a fiber laser contained within the conveyance structure. Preferably this second laser is located before the optical slip ring, or if distally from the optical slip ring is located adjacent the axle of the spool. The second laser then launches the two laser beams down long distance high power transmission fibers in the conveyance structure. The fibers are at least about 5 km long. Two fiber laser converters are locate at or near the distal end of the transmission fiber, these fiber laser may be adjacent one another, e.g., at the same distance or point along the conveyance structure, or they may be staggered along the length of the structure. Generated heat is managed by the flow of the drilling fluid down the conveyance structure. The drilling fluid is water or brine. These down hole fiber laser converters convert the 1550 nm wavelength laser beams into 810 nm laser beams. The laser beams are then transmitted by a delivery fiber to a down hole laser tool where they are delivered to the work area through the drilling fluid.

### Example 6

The laser system of Example 5 utilizes a down hole laser bottom hole assembly disclosed in US Patent Application Publ. No. 2012/0267168 to advance a borehole.

### Example 7

The laser system of Example 5, performs a perforating operation using the 810 nm wavelength laser beam in a down hole environment containing the drilling fluid.

### Example 8

The laser system of Example 5, performs a window cutting operation using the 810 nm wavelength laser beam in an downhole environment containing the drilling fluid.

### Example 9

A laser drilling system of the type disclosed in US Patent Application Publ. No. 2010/0044103, the entire disclosure of which is incorporated herein by reference, utilizes a laser conversion system of the type shown in FIG. 1. Thus the system has a 20 kW laser above ground providing a laser beam at 1070 nm. This laser beam is converted to a laser beam having 1550 nm by a fiber laser contained within the conveyance structure. Preferably this second laser is located before the optical slip ring, or if distally from the optical slip ring is located adjacent the axil of the spool. The second laser then launches the 1550 nm laser beam down long distance high power transmission fibers in the conveyance structure. The transmission fiber is at least about 1 km long. A fiber laser converter is located at or near the distal end of the transmission fiber. Generated heat is managed by the flow of the drilling fluid down the conveyance structure (or may be managed by the flow of an additional cooling fluid, such as a gas, such as air or nitrogen). The drilling fluid is water or brine. The down hole fiber laser converters convent the 1550 nm wavelength laser beam into 810 nm laser beam. The laser beam is then transmitted by a delivery fiber to a down hole laser tool where it is delivered to perform a down hole laser operation.

### Example 10

The system of Example 9 has a perforating tool of the type disclosed in U.S. patent application Ser. No. 13/782,869 the entire disclosure of which is incorporated herein by reference, and a laser perforating operation is performed in a borehole using the 810 nm wavelength laser beam.

### Example 11

The system of claim 9 has a laser tool having a fluid cutting jet of the type disclosed in US Patent Application Serial Publ. No. 2012/0074110. Down hole laser cutting operations are performed with this tool.

### Example 12

The system of claim 9 has a laser tool of the type shown in U.S. patent application Ser. No. 14/082,026 and laser fracturing operations are performed as disclosed and taught in that patent application. The entire disclosure of U.S. patent application Ser. No. 14/082,026 is incorporated herein by reference.

### Example 13

The laser systems and tools of the type disclosed in U.S. patent application Ser. Nos. 13/966,969 and 13/565,345 (the entire disclosures of each of which are incorporated herein by reference) have a laser providing a laser beam having a wavelength in the 1500s nm range, which is transmitted over a transmission fiber to a laser converter, which converts that laser beam into a laser beam having a wavelength in the 800s nm range. A laser cutting just using water as the laser jet fluid is used. Abandonment and decommissioning operation as disclosed and taught in those patent applications is performed with the 800s range laser beam in the water fluid jet.

### Example 14

A laser system for generating 810 nm laser beam(s) having 20 kW of power is position on a BOP, subsea, in a manner disclosed and described in US Patent Applications Publ. No. 2012/0217018, 2012/0217019 and 2012/0127017, the entire disclosures of each of which are incorporated herein by reference.

### Example 15

A laser system of they type shown in FIG. 1 is utilized in a laser system for a BOP laser shear ram shear of the type disclosed and described in US Patent Applications Publ. No. 2012/0217018, 2012/0217019 and 2012/0127017.

### Example 16

A laser system of they type shown in FIG. 1 is utilized in a laser system for a riser laser shear module of the type disclosed and described in US Patent Applications Publ. No. 2012/0217015, the entire disclosure of which is incorporated herein by reference.

### Example 17

An embodiment of a laser uses a Phosphor-silicate fiber, which has a much larger stokes shift per Raman order and as a consequence, 1550 nm can be generated from 1070 nm with only three resonators instead of the 7^{th} order.

### Example 18

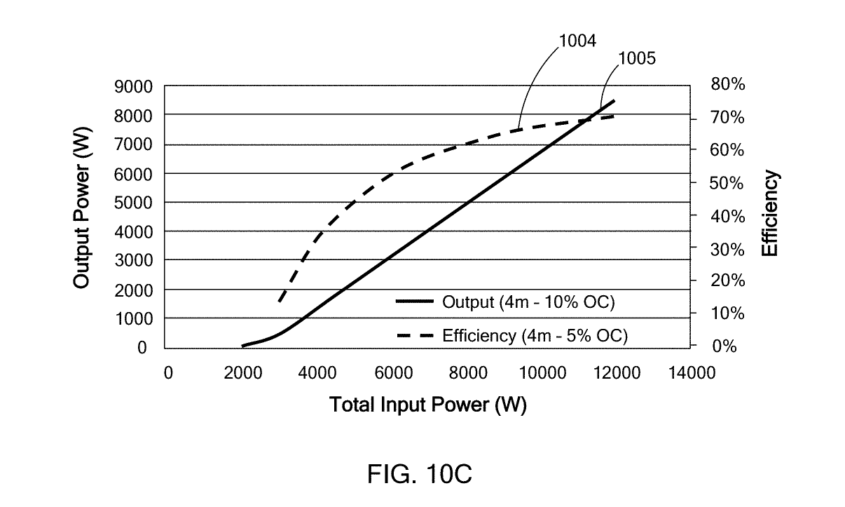

Turning to FIG. 11 there is a battery operated laser converter system 1101 contained in conveyance structure 1110. (The system 1101 could also be contained in a pressure containment vessel located for example on a BOP frame or adjacent a laser BOP shear module.) A battery pack, which could be, e.g., Lithium Ion, Lithium Iron, or Lead acid, provides electrical power through electrical transmission lines, e.g., 1104, to a several laser diodes, 1103a, 1103b, 1103c, 1103d, 1103e. It being noted that many more laser diodes would typically be utilized by only a few are shown in this figure for clarity of the illustration. The laser diodes can be staggered along the conveyance structure, or otherwise configured efficiently when considering available space, and heat management. The laser diodes pump a Thulium or equivalent upconversion laser, e.g, 1105. These laser converters deliver laser beams to laser delivery fibers, e.g., 1106, which can be combined, by a beam combiner, (not shown in the figure) or which can be provided to individual laser cutting jets. The battery pack of this embodiment may also be supplemented by electrical power lines from the surface, it may be charged or recharged by these lines, or these lines may be replaced by these electrical power lines.

### Example 19

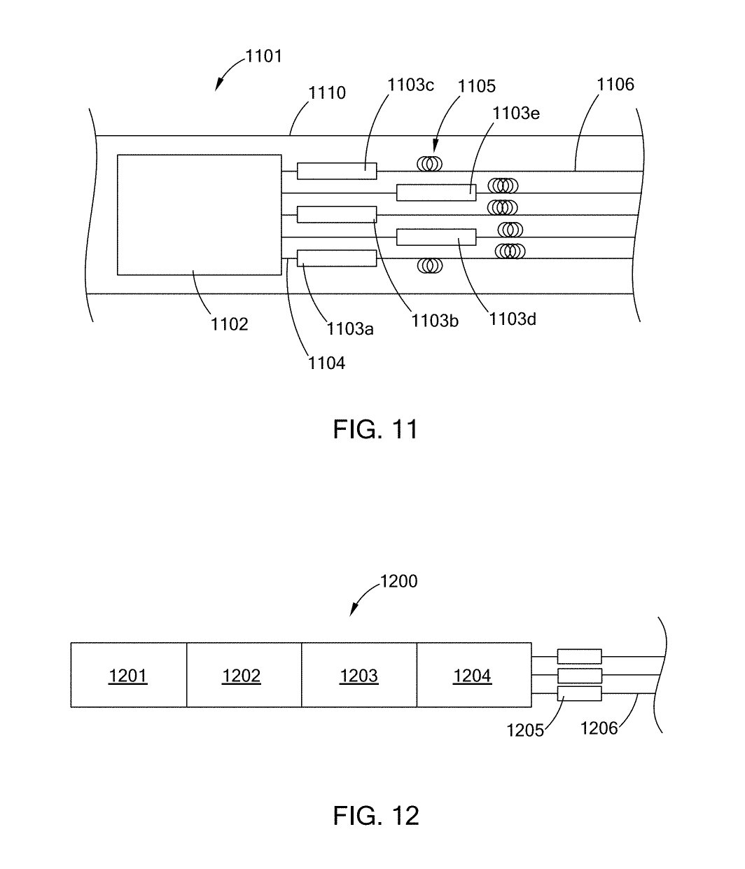

Turning to FIG. 12 there is shown an embodiment of a down hole electrical-to-opto-to-opto conversion laser conversion system 1200. There is provided a power convertor 1201, a cooling system 1202, a LD Pump 808 nm/980 nm (1203), a Nd:Glass Yt:Glass fiber laser 1204, a number of KTP laser doubling units, e.g., 1205, and delivery fibers, e.g., 1206. These delivery fibers can be combined or can be connected to a multi-laser jet delivery tool, such as the type of Example 20.

### Example 20

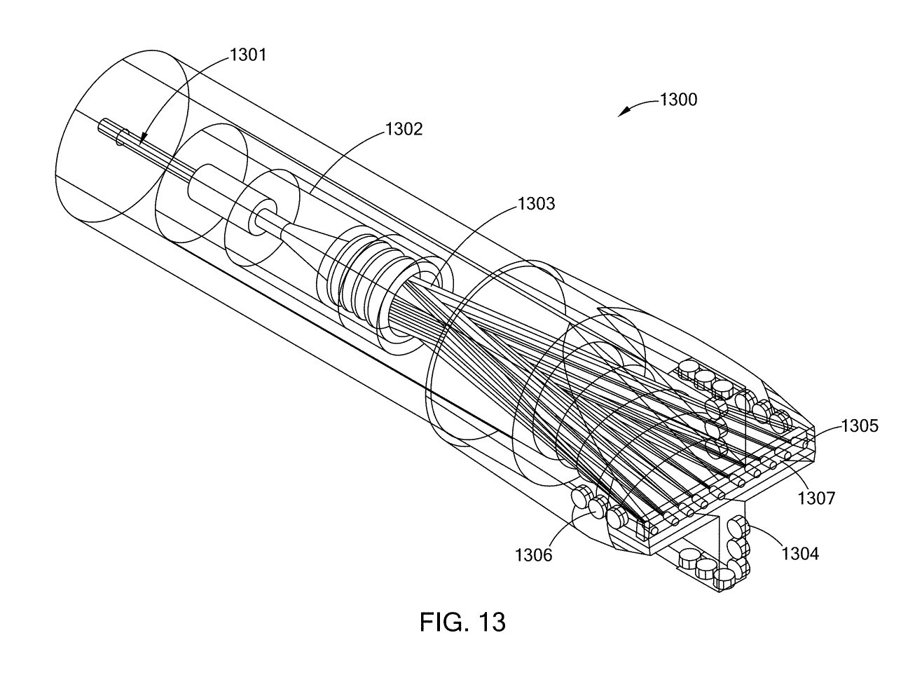

Turning to FIG. 13 there is shown an embodiment of a multi-laser jet boring bit 1300. The boring bit is designed to use the 810 nm beam created by the wavelength convertor, a 532 nm doubled laser output, or other beam which is preferentially transmitted by water. The boring bit 1300 has an optical fiber 1301 that provides a high power laser beam to bit. The beams are split up by a diffractive optic, refractive prism array or holographic beam splitter arrangement 1302 which then launches each of the beamlets 1303 into a water jet 1305. The waterjets can be created using micro/macro-channel fluid distribution system 1307 etched into glass, diamond, or a ceramic that is transparent to the operating wavelength. The bit 1300 also has PDC scrapers 1304 and tungsten carbide stabilizes 1306.

### Example 21

A laser perforating system for a fish bone borehole configuration in a shale reservoir can be used. The electrical to optical conversion, e.g., the laser that is powered by electricity from the surface is located in the spine of the borehole, and generates a laser beam having a wavelength in the 800s range. This laser beam is transmitted along a laser delivery fiber that is about 500 m long, and is associated with a laser perforating tool having a tractor for moving the laser perforating tool down the ribs of the fish bone configuration.

A conveyance structure, which may contain or be a part of a multi-laser system of the present inventions, may be coiled tubing, a tube within the coiled tubing, jointed drill pipe, jointed drill pipe having a pipe within a pipe, or may be any other type of line structure, that has the laser and/or transmission fiber associated associated with it. As used herein the term line structure should be given its broadest meaning, unless specifically stated otherwise, and would include without limitation: wireline; coiled tubing; slick line; logging cable; cable structures used for completion, workover, drilling, seismic, sensing, and logging; cable structures used for subsea completion and other subsea activities; umbilicals; cables structures used for scale removal, wax removal, pipe cleaning, casing cleaning, cleaning of other tubulars; cables used for ROV control power and data transmission; lines structures made from steel, wire and composite materials, such as carbon fiber, wire and mesh; line structures used for monitoring and evaluating pipeline and boreholes; and would include without limitation such structures as Power & Data Composite Coiled Tubing (PDT-COIL) and structures such as Smart Pipe® and FLATpak®.

Conveyance structures would include without limitation all of the high power laser transmission structures and configurations disclosed and taught in the following US Patent Applications Publication Nos.: 2010/0044106; 2010/0215326; 2010/0044103; 2012/0020631; 2012/0068006; and 2012/0266803, the entire disclosures of each of which are incorporated herein by reference.

The converter lasers and multi-laser systems may find applications in activities such as: off-shore activities; subsea activities; perforating; decommissioning structures such as, oil rigs, oil platforms, offshore platforms, factories, nuclear facilities, nuclear reactors, pipelines, bridges, etc.; cutting and removal of structures in refineries; civil engineering projects and construction and demolitions; concrete repair and removal; mining; surface mining; deep mining; rock and earth removal; surface mining; tunneling; making small diameter bores; oil field perforating; oil field fracking; well completion; window cutting; well decommissioning; well workover; precise and from a distance in-place milling and machining; heat treating; drilling and advancing boreholes; workover and completion; flow assurance; and, combinations and variations of these and other activities and operations.

A single high power laser may be utilized as the primary laser or there may be two or three high power lasers, or more for one optical path having a multi-laser system, or there may be several optical paths having a multi-laser system each having its own primary laser, and combinations and variation of these. High power solid-state lasers, specifically semiconductor lasers and fiber lasers are preferred, for the primary laser, because of their short start up time and essentially instant-on capabilities. The high power lasers for example may be fiber lasers, disk lasers or semiconductor lasers having 5 kW, 10 kW, 20 kW, 50 kW, 80 kW or more power and, which emit laser beams with wavelengths in the range from about 455 nm (nanometers) to about 2100 nm, preferably in the range about 400 nm to about 1600 nm, about 400 nm to about 800 nm, 800 nm to about 1600 nm, about 1060 nm to 1080 nm, 1530 nm to 1600 nm, 1800 nm to 2100 nm, and more preferably about 1064 nm, about 1070-1080 nm, about 1360 nm, about 1455 nm, 1490 nm, or about 1550 nm, or about 1900 nm (wavelengths in the range of 1900 nm may be provided by Thulium lasers). An example of this general type of fiber laser is the IPG YLS-20000. The detailed properties of which are disclosed in US patent application Publication Number 2010/0044106. Thus, by way of example, there is contemplated the use of four, five, or six, 20 kW lasers to provide a laser beam having a power greater than about 60 kW, greater than about 70 kW, greater than about 80 kW, greater than about 90 kW and greater than about 100 kW. One laser may also be envisioned to provide these higher laser powers.

The various embodiments of high power lasers, converters, and high power optical path multi-laser systems set forth in this specification may be used with various high power laser systems, tools, devices, and conveyance structures and systems. For example, embodiments of high power converter lasers, and high power optical path multi-laser systems may use, or be used in, or with, the systems, lasers, tools and methods disclosed and taught in the following US patent applications and patent application publications: Publication No. 2010/0044106; Publication No. 2010/0215326; Publication No. 2012/0275159; Publication No. 2010/0044103; Publication No. 2012/0267168; Publication No. 2012/0020631; Publication No. 2013/0011102; Publication No. 2012/0217018; Publication No. 2012/0217015; Publication No. 2012/0255933; Publication No. 2012/0074110; Publication No. 2012/0068086; Publication No. 2012/0273470; Publication No. 2012/0067643; Publication No. 2012/0266803; Publication No. 2012/0217019; Publication No. 2012/0217017; Publication No. 2012/0217018; Ser. No. 13/868,149; Ser. No. 13/782,869; Ser. No. 13/222,931; Ser. No. 61/745,661; and Ser. No. 61/727,096, the entire disclosure of each of which are incorporated herein by reference.

The inventions may be embodied in other forms than those specifically disclosed herein without departing from its spirit or essential characteristics. The described embodiments are to be considered in all respects only as illustrative and not restrictive.

What is claimed:

1. A high power Raman laser comprising:
a. a conversion optical fiber having a proximal end and a distal end;
b. the proximal end in optical association with a primary laser source for providing a primary laser beam to the conversion optical fiber;
c. a means for obtaining at least a 3^{rd} order Raman emission providing an emission laser beam; and,
d. a means for propagating the emission laser beam from the distal end of the conversion optical fiber.

2. The high power Raman laser of claim 1, wherein the means for obtaining the at least 3^{rd} order Raman emission comprises the optical conversion fiber having a core diameter and length between the distal and proximal ends, whereby the at least 3^{rd} Raman emission is obtained.

3. The high power Raman laser of claim 1, wherein the means for obtaining the at least 3^{rd} order Raman emission comprises a grating to reflect the wavelength of the primary laser beam.

4. The high power Raman laser of claim 1, wherein the means for obtaining the at least 3^{rd} order Raman emission comprises a mirror to reflect the wavelength of the primary laser beam.

5. The high power Raman laser of claim 1, wherein the means for obtaining the at least 3^{rd} order Raman emission comprises a grating incorporated into the conversion fiber.

6. The high power Raman laser of claim 1, wherein the means for obtaining the at least 3^{rd} order Raman emission comprises a first grating or mirror associated with the proximal end of the conversion fiber and reflective to the backward propagation of the wavelength of the primary laser beam, and a second grating or mirror associated with the distal end of the conversion fiber and reflective of the forward propagation of the wavelength of the primary laser beam.

7. The high power Raman laser of claim 1, wherein the primary laser wavelength is about 1070 nm.

8. The high power Raman laser of claim 1, wherein the primary laser wavelength is about 1060 nm to 1080 nm.

9. The high power Raman laser of claim 1, wherein the primary laser beam is a broad band laser beam.

10. The high power Raman laser of claim 9, wherein the primary laser wavelength is about 1060 nm to 1080 nm

11. The high power Raman laser of claim 9, wherein the primary laser wavelength is about 1070 nm.

12. The high power Raman laser of claim 11, wherein the means for obtaining the at least 3^{rd} order Raman emission comprises the optical conversion fiber having a core diameter and length between the distal and proximal ends, whereby the at least 3^{rd} Raman emission is obtained.

13. The high power Raman laser of claim 11, wherein the means for obtaining the at least 3^{rd} order Raman emission comprises a grating to reflect the wavelength of the primary laser beam.

14. The high power Raman laser of claim 11, wherein the means for obtaining the at least 3^{rd} order Raman emission comprises a mirror to reflect the wavelength of the primary laser beam.

15. The high power Raman laser of claim 11, wherein the means for obtaining the at least 3^{rd} order Raman emission comprises a grating incorporated into the conversion fiber.

16. The high power Raman laser of claim 11, wherein the means for obtaining the at least 3^{rd} order Raman emission comprises a first grating or mirror associated with the proximal end of the conversion fiber and reflective to the backward propagation of the wavelength of the primary laser beam, and a second grating or mirror associated with the distal end of the conversion fiber and reflective of the forward propagation of the wavelength of the primary laser beam.

17. The high power Raman laser of claim 11, wherein the emission laser beam has a wavelength of about 1550 nm.

18. The high power Raman laser of claim 17, wherein the means for obtaining the at least 3^{rd} order Raman emission comprises the optical conversion fiber having a core diameter and length between the distal and proximal ends, whereby the at least 3^{rd} Raman emission is obtained.

19. The high power Raman laser of claim 17, wherein the means for obtaining the at least 3^{rd} order Raman emission comprises a grating to reflect the wavelength of the primary laser beam.

20. The high power Raman laser of claim 17, wherein the means for obtaining the at least 3^{rd} order Raman emission comprises a mirror to reflect the wavelength of the primary laser beam.

21. The high power Raman laser of claim 17, wherein the means for obtaining the at least 3^{rd} order Raman emission comprises a grating incorporated into the conversion fiber.

22. The high power Raman laser of claim 17, wherein the means for obtaining the at least 3^{rd} order Raman emission comprises a first grating or mirror associated with the proximal end of the conversion fiber and reflective to the backward propagation of the wavelength of the primary laser beam, and a second grating or mirror associated with the distal end of the conversion fiber and reflective of the forward propagation of the wavelength of the primary laser beam.

23. The high power Raman laser of claim 1, comprising
a. a means for obtaining at least a 3^{rd} order Raman emission providing a second emission laser beam; and,
b. a means for propagating the second emission laser beam from the distal end of the conversion optical fiber.

24. The high power Raman laser of claim 23, wherein the primary laser beam is a broad band laser beam.

25. The high power Raman laser of claim 24, wherein the primary laser wavelength is about 1060 nm to 1080 nm

26. The high power Raman laser of claim 25, wherein the primary laser wavelength is about 1070 nm.

27. The high power Raman laser of claim 25, wherein the emission laser beam has a wavelength of about 1460 nm and the second emission laser beam has a wavelength of about 1660 nm.

28. The high power Raman laser of claim 27, wherein the means for obtaining the at least 3^{rd} order Raman emission comprises the optical conversion fiber having a core diameter and length between the distal and proximal ends, whereby the at least 3^{rd} Raman emission is obtained.

29. The high power Raman laser of claim 27, wherein the means for obtaining the at least 3^{rd} order Raman emission comprises a grating to reflect the wavelength of the primary laser beam.

30. The high power Raman laser of claim 27, wherein the means for obtaining the at least 3^{rd} order Raman emission comprises a mirror to reflect the wavelength of the primary laser beam.

31. The high power Raman laser of claim 27, wherein the means for obtaining the at least 3^{rd} order Raman emission comprises a grating incorporated into the conversion fiber.

32. The high power Raman laser of claim 27, wherein the means for obtaining the at least 3^{rd} order Raman emission comprises a first grating or mirror associated with the proximal end of the conversion fiber and reflective to the backward propagation of the wavelength of the primary laser beam, and a second grating or mirror associated with the distal end of the conversion fiber and reflective of the forward propagation of the wavelength of the primary laser beam.

33. The high power Raman laser of claim 1, wherein the primary laser has a power of at least about 10 kW.

34. The high power Raman laser of claim 6, wherein the primary laser has a power of at least about 10 kW.

35. The high power Raman laser of claim 8, wherein the primary laser has a power of at least about 10 kW.

36. The high power Raman laser of claim 9, wherein the primary laser has a power of at least about 10 kW.

37. The high power Raman laser of claim 16, wherein the primary laser has a power of at least about 10 kW.

38. The high power Raman laser of claim 17, wherein the primary laser has a power of at least about 10 kW.

39. The high power Raman laser of claim 23, wherein the primary laser has a power of at least about 10 kW.

40. The high power Raman laser of claim 27, wherein the primary laser has a power of at least about 10 kW.

41. The high power Raman laser of claim 1, wherein the primary laser has a power of at least about 20 kW.

42. The high power Raman laser of claim 17, wherein the primary laser has a power of at least about 20 kW.

43. The high power Raman laser of claim 27, wherein the primary laser has a power of at least about 20 kW.

44. The high power Raman laser of claim 1, wherein the primary laser has a power of at least about 50 kW.

45. The high power Raman laser of claim 16, wherein the primary laser has a power of at least about 50 kW.

46. The high power Raman laser of claim 1, wherein the emission laser has a power of at least about 10 kW.

47. The high power Raman laser of claim 6, wherein the emission laser has a power of at least about 20 kW.

48. The high power Raman laser of claim 8, wherein the emission laser has a power of at least about 40 kW.

49. The high power Raman laser of claim 9, wherein the emission laser has a power of at least about 10 kW.

50. The high power Raman laser of claim 16, wherein the emission laser has a power of at least about 10 kW.

51. The high power Raman laser of claim 41, wherein the emission laser has a power of at least about 10 kW.

52. The high power Raman laser of claim 1, wherein a Raman emission is a stokes emission.

53. The high power Raman laser of claim 1, wherein a Raman emission is an antistokes emission.

54. The high power Raman laser of claim 6, wherein a Raman emission is a stokes emission.

55. The high power Raman laser of claim 6, wherein a Raman emission is an antistokes emission.

56. The high power Raman laser of claim 27, wherein a Raman emission is a stokes emission.

57. The high power Raman laser of claim 27, wherein a Raman emission is an antistokes emission.

58. The high power Raman laser of claim 51, wherein a Raman emission is a stokes emission.

59. The high power Raman laser of claim 51, wherein a Raman emission is an antistokes emission.

60. A high power Raman laser comprising:
a. a conversion optical fiber having a proximal end and a distal end;
b. the proximal end in optical association with a primary laser source for providing a primary laser beam to the conversion optical fiber;
c. a means for obtaining at least a 5^{th} order Raman emission providing an emission laser beam; and,
d. a means for propagating the emission laser beam from the distal end of the conversion optical fiber.

61. The high power Raman laser of claim 60, wherein the means for obtaining the at least 5^{th} order Raman emission comprises a first grating or mirror associated with the proximal end of the conversion fiber and reflective to the backward propagation of the wavelength of the primary laser beam, and a second grating or mirror associated with the distal end of the conversion fiber and reflective of the forward propagation of the wavelength of the primary laser beam.

62. The high power Raman laser of claim 60, wherein the emission laser beam has a wavelength of about 1550 nm.

63. The high power Raman laser of claim 60, wherein the primary laser wavelength is about 1060 nm to 1080 nm.

64. The high power Raman laser of claim 60, wherein the primary laser beam is a broad band laser beam.

65. The high power Raman laser of claim 60, comprising
a. a means for obtaining at least a 3^{rd} order Raman emission providing a second emission laser beam; and,
b. a means for propagating the second emission laser beam from the distal end of the conversion optical fiber.

66. The high power Raman laser of claim 65, wherein the emission laser beam has a wavelength of about 1460 nm and the second emission laser beam has a wavelength of about 1660 nm.

67. The high power Raman laser of claim 60, wherein the primary laser has a power of at least about 10 kW.

68. The high power Raman laser of claim 60, wherein the primary laser has a power of at least about 20 kW.

69. The high power Raman laser of claim 60, wherein the primary laser has a power of at least about 50 kW.

70. The high power Raman laser of claim 60, wherein the emission laser has a power of at least about 10 kW.

71. The high power Raman laser of claim 60, wherein the emission laser has a power of at least about 20 kW.

72. The high power Raman laser of claim 68, wherein the emission laser has a power of at least about 10 kW.

73. The high power Raman laser of claim 60, wherein a Raman emission is a stokes emission.

74. The high power Raman laser of claim 60, wherein a Raman emission is an antistokes emission.

75. A high power Raman laser comprising:
a. a conversion optical fiber having a proximal end and a distal end;
b. the proximal end in optical association with a primary laser source for providing a primary laser beam to the conversion optical fiber, the primary wavelength having a wavelength a power of at least about 20 kW;
c. the conversion optical fiber capable of interacting with the primary laser beam to provide Raman scattering and to provide an increased order Raman emission having a power of at least about 5 kW; and,
d. the distal end capable of transmitting the Raman emission.

76. The high power Raman laser of claim 75, wherein a Raman emission is a stokes emission.

77. The high power Raman laser of claim 75, wherein a Raman emission is an antistokes emission.

78. The high power Raman laser of claim 75, wherein the emission laser beam wavelength is at least about 100 nm greater than the primary laser beam wavelength.

79. The high power Raman laser of claim 75, wherein the emission laser beam wavelength is at least about 200 nm greater than the primary laser beam wavelength.

80. The high power Raman laser of claim 75, wherein the emission laser beam wavelength is at least about 300 nm greater than the primary laser beam wavelength.

81. The high power Raman laser of claim 75, wherein the emission laser beam wavelength is at least about 500 nm greater than the primary laser beam wavelength.

82. A method of converting the wavelength of a laser beam along an optical path through the generation of 3^{rd} order and greater Raman emissions, the method comprising: propagating a high power laser having at least about 10 kW of power along an optical path in a fiber, the optical path having a length and the fiber having a length; and generating 3^{rd} order Raman emissions along the optical path in the fiber.

83. The method of claim 82, comprising generating 5^{th} order Raman emissions.

84. The method of claim 82, comprising generating 6^{th} order Raman emissions.

85. The method of claim 82, comprising generating 7^{th} order Raman emissions.

86. The method of claim 82, wherein the optical path is longer than the fiber length.

87. The method of claim 82, wherein the optical path is about the same length as the fiber.

88. The method of claim 82, wherein the optical path is at least about 10× longer than the length of the fiber.

89. A method of converting in a borehole in the earth the wavelength of a laser beam along an optical path through the generation of 3^{rd} order and greater Raman emissions, the method comprising: positioning at least a portion of a fiber in a borehole in the earth; propagating a high power laser having at least about 10 kW of power along an optical path in the fiber, the optical path having a length and the fiber having a length; and generating 3^{rd} order Raman emissions along the optical path in the fiber.

90. The method of claim 89, comprising generating 6^{th} order Raman emissions.

91. The method of claim 89, comprising generating 6^{th} order Raman emissions.

92. The method of claim 89, comprising generating 7^{th} order Raman emissions.

93. A method of converting under the surface of a body of water the wavelength of a laser beam along an optical path through the generation of 3^{rd} order and greater Raman emissions, the method comprising: positioning at least a portion of a fiber under a surface of a body of water; propagating a high power laser having at least about 10 kW of power along an optical path in the fiber, the optical path having a length and the fiber having a length; and generating 3^{rd} order Raman emissions along the optical path in the fiber.

94. The methods of claim 93, wherein the laser beam has a power of at least 20 kW.

95. The methods of claim 93, wherein the laser beam has a power of at least 40 kW.

96. An optical path multi-wavelength laser system, the system comprising:
a. a primary laser for providing a first laser beam having a first wavelength and a power of at least about 20 kW;
b. a first converter laser in optical communication with the primary laser, whereby the first laser beam is received by the first converter laser; the first converter laser capable of generating a second laser beam having a predetermined wavelength and a power of at least about 5 kW; and,
c. the second laser beam wavelength selected based upon an environmental condition.

97. The optical path multi-wavelength laser system of claim 96, wherein the environmental condition is long distance transmission of the laser beam over a fiber, and the wavelength is selected from the group consisting of about 1660 nm, about 1550 nm, and about 1460 nm.

98. The optical path multi-wavelength laser system of claim 97, comprising a second converter laser in optical communication with the first converter laser, whereby the second laser beam is received by the second converter laser; the second upconverter laser capable of generating a third laser beam having a second predetermined wavelength and a power of at least about 3 kW; and the third laser beam wavelength selected based upon a second environmental condition.

99. The optical path multi-wavelength laser system of claim 97, wherein the second environmental condition is borehole fluids, and the second wavelength is selected from the group consisting of about 880 nm and about 460 nm.

100. A high power Thulium rare earth ion conversion laser, the laser comprising:
a. an optical fiber having a core and a cladding;
b. the core comprising fused silica, Thulium and a dopant;
c. the optical fiber having a distal end and a proximal end, whereby the proximal end is in optical association with a pump laser having a wavelength; and,
d. the optical fiber, pump wavelength, amount of Thulium and amount of dopant, configured to provide stimulated emissions from the ³H₄ energy level, to provide a laser beam having a wavelength of about 810 nm.

101. The high power Thulium rare earth ion conversion laser of claim 100, wherein the dopant is selected from the group consisting of Germanium, and Alumina.

102. A method of generating a high power laser beam in a borehole in the earth, the method comprising:
a. lowering a Thulium conversion laser into a borehole;
b. transmitting high power laser energy to the Thulium conversion;
c. generating a laser beam having a wavelength of about 400 nm to about 900 nm within the borehole.

103. The method of claim 102, wherein the wavelength is about 460 nm.

104. The method of claim 102, wherein the wavelength is about 810 nm.

105. The method of claim 102, wherein the laser beam is generated at a location at least 1,000 feet within a borehole and has a power of at least about 5 kW.

106. The method of claim 103, wherein the laser beam is generated at a location at least 1,000 feet within a borehole and has a power of at least about 5 kW.

107. The method of claim 104, wherein the laser beam is generated at a location at least 1,000 feet within a borehole and has a power of at least about 5 kW.

108. The method of claim 102, wherein the laser beam is generated at a location at least 5,000 feet within a borehole and has a power of at least about 5 kW.

109. The method of claim 103, wherein the laser beam is generated at a location at least 5,000 feet within a borehole and has a power of at least about 5 kW.

110. The method of claim 102, wherein the laser beam is generated at a location at least 1,000 feet within a borehole and has a power of at least about 15 kW.

111. The method of claim 103, wherein the laser beam is generated at a location at least 1,000 feet within a borehole and has a power of at least about 15 kW.

112. The method of claim 104, wherein the laser beam is generated at a location at least 1,000 feet within a borehole and has a power of at least about 15 kW.

113. The method of claim 102, wherein the laser beam is generated at a location at least 3,000 feet within a borehole and has a power of at least about 20 kW.

114. A method of transmitting and using high power laser energy for drilling, pressure management, decommissioning, perforating or workover and completion activities, in the exploration or production of hydrocarbons, the method comprising:
a. creating a first laser beam from a first laser, the first laser beam having a power of at least about 15 kW;
b. transmitting the first laser beam to a second laser for creating a second laser beam;
c. transmitting the second laser beam; and,
d. delivering a laser beam from a high power laser tool to a target to perform a laser operation.

115. The method of claim 114, wherein the laser operation is selected from the group consisting of perforating, fracturing, decommissioning, drilling, pipe cutting and window milling.

116. A method of transmitting and using high power laser energy for drilling, pressure management, decommissioning, perforating or workover and completion activities, in the exploration or production of hydrocarbons, the method comprising:
a. generating a first laser beam from a first laser, the first laser beam having a power of at least about 15 kW;
b. transmitting the first laser beam to a second laser for generating a second laser beam, whereby the second laser generates the second laser beam;
c. transmitting the second laser beam to a third laser for generating a third laser beam, whereby the third laser generates the third laser beam;
d. transmitting the third laser beam to a laser tool; and delivering the third laser beam from the laser tool to a target; and,
e. thereby performing a laser operation using the third laser beam on the target.

117. The method of claim 116, wherein the first laser beam has a first wavelength, the second laser beam has a second wavelength, and the third laser beam has a third wavelength; the first, second and third wavelengths being different from each other.

118. The method of claim 117 wherein the first wavelength is selected in part to enhance the generation of the second laser beam.

119. The method of claim 118, wherein the second laser wavelength is selected in part to enhance the transmission of the second laser beam over fiber distances of at least about 1,000 feet.

120. The method of claim 117, wherein the third wavelength is selected in part to enhance the transmission of the laser beam through a predetermined free space environment, the free space environment comprising an aqueous media.

121. The method of claim 117 wherein the first wavelength is selected in part to enhance the generation of the second laser beam, the second laser wavelength is selected in part to enhance the transmission of the second laser beam over fiber distances of at least about 1,000 feet and to enhance the generation of the third laser beam, and the third wavelength is selected in part to enhance the transmission of the third laser beam through a predetermined free space environment, the free space environment comprising an aqueous media.

122. A high power laser system, the system comprising:
a. a first laser for creating a first laser beam having a first wavelength and having a power of at least about 15 kW;
b. a second laser for creating a second laser beam having a second wavelength, the second laser in optical communication with the first laser, whereby the first laser provides a pump source for the second laser; and,
c. the second wavelength having a wavelength that is at least 500 nm smaller than the first wavelength.

123. A high power laser system, the system comprising:
a. a first laser for creating a first laser beam having a first wavelength and having a power of at least about 10 kW;
b. a second laser for creating a second laser beam having a second wavelength, the second laser in optical communication with the first laser, whereby the first laser provides a pump source for the second laser;
c. the second laser in optical communication, by way of a high power laser fiber having a length of at least about 2,000 feet, with a third laser for creating a third laser beam, whereby the second laser beam provides a pump source for the third laser; and,
d. the third laser in optical communication with a laser tool, whereby the laser tool is configured to deliver the third laser beam to a target.

124. The method of claim 123, wherein the first wavelength is selected in part to enhance the pumping of the second laser, the second laser wavelength is selected in part to enhance the transmission of the second laser beam over fiber and to enhance the pumping of the third laser, and the third wavelength is selected in part to enhance the delivery of the third laser beam to the target through a predetermined free space environment, the free space environment comprising an aqueous media.
